(19) United States
(12) Patent Application Publication
(10) Pub. No.: US 2009/0070946 A1
(43) Pub. Date: Mar. 19, 2009

(54) APPARATUS FOR AND METHOD OF PROCESSING SUBSTRATE

(75) Inventors: Osamu Tamada, Kyoto (JP); Masakazu Sanada, Kyoto (JP); Tadashi Miyagi, Kyoto (JP); Shuichi Yasuda, Kyoto (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sokudo Co., Ltd., Kyoto (JP)

(21) Appl. No.: 12/211,549

(22) Filed: Sep. 16, 2008

(30) Foreign Application Priority Data
Sep. 18, 2007 (JP) JP2007-240919

(51) Int. Cl. B08B 3/04; B08B 3/12

(52) U.S. Cl. 15/21.1; 134/1; 134/61; 134/62; 134/34; 134/6

(57) ABSTRACT

A cleaning processing part including an edge cleaning processing unit for cleaning an edge of a substrate is provided in an indexer block. An indexer robot provided in the indexer block transports an unprocessed substrate taken out of a cassette to the cleaning processing part before transporting the unprocessed substrate to an anti-reflection film processing block serving as a processor. The cleaning processing part cleans an edge and a back surface of a substrate.

### CROSS-REFERENCES TO RELATED APPLICATIONS

This application claims priority to Japanese Patent Application 2007-240919, filed Sep. 18, 2007. The disclosure of JP 2007-240919 is hereby incorporated by reference its entirety for all purposes.

### BACKGROUND OF THE INVENTION

The present invention relates to a substrate processing apparatus which processes a substrate such as a semiconductor substrate, a glass substrate for a liquid crystal display device, a substrate for a plasma display, a substrate for an optical disk, a substrate for a magnetic disk, a substrate for a magnetic optical disk, a glass substrate for a photomask, and the like, and to a method of processing such a substrate.

### Description of the Background Art

Semiconductor device products, liquid crystal display products and the like are fabricated by performing a series of processes (for example, a series of processes including cleaning, resist coating, exposure, development, etching, interlayer insulation film formation, heat treatment, dicing and the like) on a substrate.

A substrate processing apparatus which performs these processes includes, for example, a plurality of processing blocks (including an anti-reflection film processing block for forming an anti-reflection film on a substrate surface, a resist film processing block for applying a resist film onto the anti-reflection film, a development processing block for developing an exposed substrate, and the like) provided in juxtaposition, and is disposed adjacent to an exposure apparatus which performs an exposure process.

A substrate is subjected to such a series of processes while being transported to the processing blocks in predetermined sequence. Specifically, unprocessed substrates stored in a cassette are carried one by one out of the cassette by a transport apparatus, and a substrate carried by the transport apparatus is transported via an indexer block into the anti-reflection film processing block. In the anti-reflection film processing block, the anti-reflection film is formed on the surface of the substrate. The substrate with the anti-reflection film formed thereon is subsequently transported into the resist film processing block, and is coated with the resist film therein. The substrate with the resist film formed thereon is carried from the substrate processing apparatus to the exposure apparatus which is an external apparatus, and is subjected to the exposure process therein. The substrate subjected to the exposure process is transported again into the substrate processing apparatus, and is then developed in the development processing block. The substrate with a resist pattern formed on the surface thereof by being subjected to these processes is transported via the indexer block and stored into a cassette again.

The unprocessed substrates stored in a cassette are not always clean. The execution of the series of processes on an unclean substrate gives rise to a defect. Also, the transport of a substrate with particles and the like deposited on an edge and a back surface thereof into a track causes cross contamination of the track and the exposure apparatus.

In particular, for an exposure apparatus which performs the exposure process by an immersion method (an exposure method which fills the space between a projection optical system and a substrate with a liquid having a refractive index n (e.g., deionized water with n=1.44) higher than that of the atmosphere (n=1) to shorten the wavelength of exposure light at the surface of the substrate, thereby achieving the formation of a fine exposure pattern), there is apprehension that the particles and the like deposited on an edge and a back surface of the substrate contaminate a lens in the exposure apparatus resulting in failures in size and shape of the exposure pattern.

To avoid such a problem, there has been proposed a substrate processing apparatus which includes a processing block (an edge cleaning processing block) for cleaning an edge of a substrate (as disclosed in Japanese Patent Application Laid-Open No. 2007-5659). In the substrate processing apparatus, the edge cleaning processing block cleans the edge of the substrate to prevent contamination in the exposure apparatus.

The structure disclosed in Japanese Patent Application Laid-Open No. 2007-5659 can prevent a situation in which the particles and the like deposited on the edge of the substrate contaminate the interior of the exposure apparatus. However, the structure provided with the processing block for cleaning the edge of the substrate presents a problem such that the footprint of the apparatus is increased.

### SUMMARY OF THE INVENTION

The present invention is intended for a substrate processing apparatus. According to one aspect of the present invention, the substrate processing apparatus comprises: a processor including at least one processing unit for performing a predetermined process on a substrate; and an indexer part for receiving an unprocessed substrate from outside to transfer the unprocessed substrate to the processor and for receiving a processed substrate from the processor to transport the processed substrate to outside, the indexer part including an edge cleaning part for cleaning an edge of a substrate prior to the transfer of the substrate to the processor.

According to this configuration, the provision of the edge cleaning part for cleaning an edge of a substrate in the indexer part accomplishes savings in space for the apparatus. Further, the edge cleaning part is capable of cleaning the edge of the substrate prior to the transfer of the substrate to the processor to thereby make the edge of the substrate to be transported into the processor clean. This avoids the occurrence of a defect and the cross contamination of the processor.

Preferably, the edge cleaning part includes: an ultrasonic vibration application element for applying ultrasonic vibration to a predetermined cleaning liquid; and a discharge nozzle for supplying the predetermined cleaning liquid applied with the ultrasonic vibration to an edge of a substrate to be cleaned.

This configuration allows the supply of the cleaning liquid applied with the ultrasonic vibration to the edge of the substrate, thereby effectively removing particles deposited on the edge of the substrate.

Preferably, the edge cleaning part further includes a puddle formation member of an inclined U-shaped cross-sectional configuration such that opposite horizontal end portions thereof are open, and the edge cleaning part discharges the predetermined cleaning liquid from the discharge nozzle into an interior space of the puddle formation member to form a puddle, and immerses the edge of the substrate to be cleaned in the puddle to clean the edge of the substrate to be cleaned.

According to this construction, the edge of the substrate to be cleaned is immersed in the puddle of cleaning liquid. Thus, the entire edge of the substrate is brought into contact with the cleaning liquid with reliability. This produces a high cleaning effect.

Preferably, the edge cleaning part includes a two-fluid nozzle for mixing a predetermined cleaning liquid and a pressurized gas together to form droplets of the predetermined cleaning liquid, thereby supplying the droplets of the predetermined cleaning liquid to an edge of a substrate to be cleaned.

This configuration allows the supply of the droplets of cleaning liquid formed by mixing the cleaning liquid and the pressurized gas together to the edge of the substrate. This effectively removes particles deposited on the edge of the substrate.

Preferably, the edge cleaning part includes: a cleaning liquid supply element for supplying a predetermined cleaning liquid to a substrate to be cleaned; and a cleaning brush for making sliding contact with an edge of the substrate to be cleaned.

This configuration brings the cleaning brush into sliding contact with the edge of the substrate to thereby remove the particles deposited on the edge of the substrate with reliability.

Preferably, the indexer part further includes: an inverting part for inverting a substrate prior to the transfer of the substrate to the processor upside down; and a back surface cleaning part for cleaning a back surface of a substrate prior to the transfer of the substrate to the processor.

This configuration is capable of cleaning the back surface of the substrate prior to the transfer of the substrate to the processor to thereby make the back surface of the substrate to be transported into the processor clean. This prevents the particles and the like deposited on the back surface of the substrate from contaminating the processor. Additionally, the provision of the back surface cleaning part in the indexer part accomplishes savings in space for the apparatus.

Preferably, the indexer part further includes: a cassette table for placing thereon a cassette for storing a plurality of substrates therein; and a substrate transport device for holding a substrate with a predetermined holding element to transport the substrate between the cassette, the processor and the edge cleaning part, the substrate transport device including a first holding element for holding a substrate prior to the cleaning of an edge thereof and a second holding element for holding a substrate after the cleaning of an edge thereof.

According to this configuration, the holding element for holding a substrate prior to the cleaning of an edge thereof and the holding element for holding a substrate after the cleaning of an edge thereof are used properly depending on the purposes. This avoids a situation in which an unclean holding element holds the substrate after the cleaning of the edge thereof to contaminate the substrate again.

The present invention is also intended for a method of processing a substrate.

It is therefore an object of the present invention to provide an apparatus for and a method of processing a substrate which are capable of avoiding problems (including the occurrence of a defect, the cross contamination of a track and an exposure apparatus and the like) resulting from the contamination of an edge of the substrate while accomplishing savings in space for the apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view showing the overall construction of a substrate processing apparatus;

FIGS. 2 and 3 are side views showing the overall construction of the substrate processing apparatus;

FIG. 4 is a flow diagram showing the operation of the substrate processing apparatus;

FIGS. 5A and 5B are views showing an example of the layout of an indexer block;

FIG. 6 is a view showing a unit configuration of a cleaning processing part;

FIG. 7 is a view showing the general construction of an edge cleaning processing unit;

FIGS. 8A and 8B are views showing an inclined U-shaped nozzle;

FIG. 9 is a perspective view showing the construction of major parts of an inverting unit;

FIG. 10 is a schematic front view of the inverting unit;

FIG. 11 is a view showing the construction of a back surface cleaning unit;

FIG. 12 is a flow diagram showing the operation of the cleaning processing unit;

FIGS. 13A, 13B, 14A and 14B are views showing modifications of the layout of the indexer block;

FIG. 15 is a view showing a modification of the overall construction of the edge cleaning processing unit;

FIG. 16 is a side view showing the construction of a brush;

FIG. 17 is a view showing another modification of the overall construction of the edge cleaning processing unit;

FIG. 18 is a side sectional view showing a two-fluid nozzle; and

FIG. 19 is a view showing a modification of the unit configuration of the cleaning processing part.

### DETAILED DESCRIPTION OF SPECIFIC EMBODIMENTS

A substrate processing apparatus 500 according to an embodiment of the present invention will be described with reference to the drawings. A common XYZ rectangular coordinate system is additionally shown in figures to which reference is made in the description below for purposes of clarifying the positions of respective parts relative to each other and the directions of operations.

1. Construction of Substrate Processing Apparatus 500

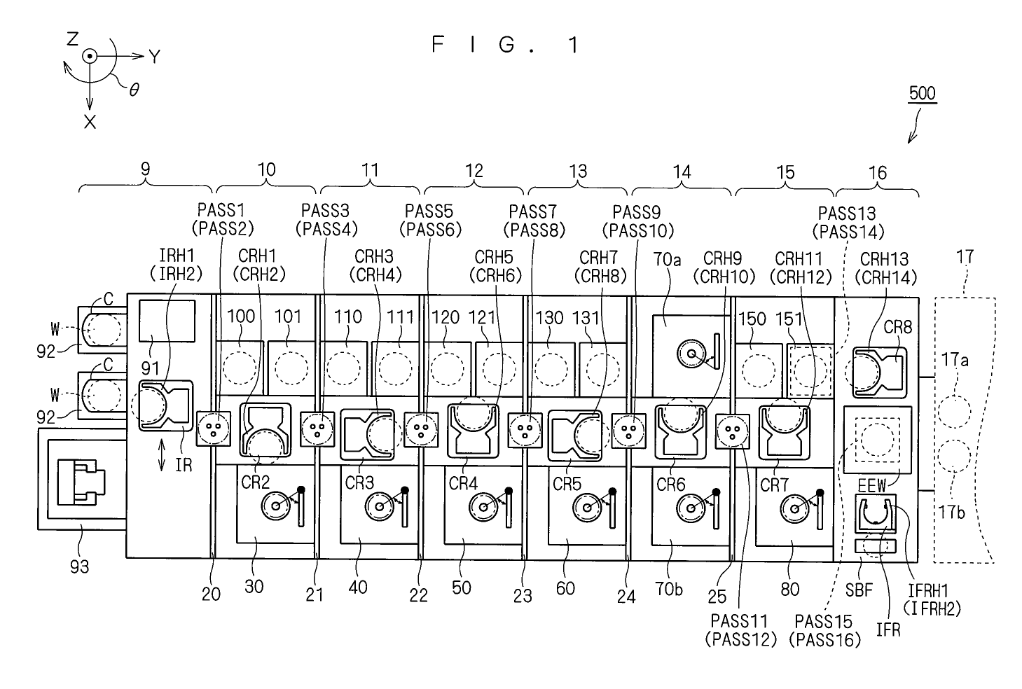

First, the overall construction of the substrate processing apparatus 500 will be described with reference to FIGS. 1 to 3. FIG. 1 is a plan view showing the overall construction of the substrate processing apparatus 500. The substrate processing apparatus 500 is an apparatus for performing a series of processes including a coating process, a heat treatment, a development process and the like upon a substrate W before and after an immersion exposure process.

The substrate processing apparatus 500 principally includes an indexer block 9 and a plurality of processors (i.e., an anti-reflection film processing block 10, a resist film processing block 11, a development processing block 12, a resist cover film processing block 13, a resist cover film removal block 14, a cleaning/drying processing block 15 and an interface block 16) which are provided in juxtaposition in the order named. Each of the plurality of processors includes one or more processing units disposed therein for performing a predetermined process on a substrate W transported from the indexer block 9 thereinto.

An exposure apparatus 17 separate from the substrate processing apparatus 500 is connected to the (+Y) side of the interface block 16. The exposure apparatus 17 has the function of performing an immersion exposure process on a substrate W.

The indexer block 9 is a functional part for receiving an unprocessed substrate from the outside of the substrate processing apparatus 500 to transfer the unprocessed substrate to a processor, and for receiving a processed substrate from a processor to transport the processed substrate to the outside of the substrate processing apparatus 500. More specifically, the indexer block 9 takes an unprocessed substrate out of a cassette (carrier) C which stores a plurality of substrates W therein to transfer the unprocessed substrate to the anti-reflection film processing block 10 which is a processor, and receives a processed substrate from the anti-reflection film processing block 10 to store the processed substrate into a cassette C.

The indexer block 9 includes a main controller 91 for controlling the operation of each block, one or more cassette tables 92, a cleaning processing part 93, and an indexer robot IR. The indexer robot IR has a pair of hands IRH1 and IRH2 arranged vertically for transferring a substrate W. One hand IRH1 (a pre-cleaning hand IRH1) is used for the transport of a substrate W prior to the cleaning process of the substrate W in the cleaning processing part 93, and the other hand IRH2 (a post-cleaning hand IRH2) is used for the transport of a substrate W after the cleaning process of the substrate W in the cleaning processing part 93. The layout of the indexer block 9 will be described later.

The anti-reflection film processing block 10 includes anti-reflection film heat treatment parts 100 and 101, an anti-reflection film coating processing part 30, and a second center robot CR2. The anti-reflection film heat treatment parts 100 and 101 and the anti-reflection film coating processing part 30 are disposed on opposed sides of the second center robot CR2. The second center robot CR2 has a pair of hands CRH1 and CRH2 arranged vertically for transferring a substrate W.

A partition 20 for closing off the communication of atmosphere is provided between the indexer block 9 and the anti-reflection film processing block 10. The partition 20 is provided with a pair of substrate rest parts PASS1 and PASS2 arranged vertically in proximity to each other and each for transferring a substrate W between the indexer block 9 and the anti-reflection film processing block 10. The upper substrate rest part PASS1 is used for the transport of a substrate W from the indexer block 9 to the anti-reflection film processing block 10. The lower substrate rest part PASS2, on the other hand, is used for the transport of a substrate W from the anti-reflection film processing block 10 to the indexer block 9.

The resist film processing block 11 includes resist film heat treatment parts 110 and 111, a resist film coating processing part 40, and a third center robot CR3. The resist film heat treatment parts 110 and 111 and the resist film coating processing part 40 are disposed on opposed sides of the third center robot CR3. The third center robot CR3 has a pair of hands CRH3 and CRH4 arranged vertically for transferring a substrate W.

A partition 21 for closing off the communication of atmosphere is provided between the anti-reflection film processing block 10 and the resist film processing block 11. The partition 21 is provided with a pair of substrate rest parts PASS3 and PASS4 arranged vertically in proximity to each other and each for transferring a substrate W between the anti-reflection film processing block 10 and the resist film processing block 11. The upper substrate rest part PASS3 is used for the transport of a substrate W from the anti-reflection film processing block 10 to the resist film processing block 11. The lower substrate rest part PASS4, on the other hand, is used for the transport of a substrate W from the resist film processing block 11 to the anti-reflection film processing block 10.

The development processing block 12 includes development heat treatment parts 120 and 121, a development processing part 50, and a fourth center robot CR4. The development heat treatment parts 120 and 121 and the development processing part 50 are disposed on opposed sides of the fourth center robot CR4. The fourth center robot CR4 has a pair of hands CRH5 and CRH6 arranged vertically for transferring a substrate W.

A partition 22 for closing off the communication of atmosphere is provided between the resist film processing block 11 and the development processing block 12. The partition 22 is provided with a pair of substrate rest parts PASS5 and PASS6 arranged vertically in proximity to each other and each for transferring a substrate W between the resist film processing block 11 and the development processing block 12. The upper substrate rest part PASS5 is used for the transport of a substrate W from the resist film processing block 11 to the development processing block 12. The lower substrate rest part PASS6, on the other hand, is used for the transport of a substrate W from the development processing block 12 to the resist film processing block 11.

The resist cover film processing block 13 includes resist cover film heat treatment parts 130 and 131, a resist cover film coating processing part 60, and a fifth center robot CR5. The resist cover film heat treatment parts 130 and 131 and the resist cover film coating processing part 60 are disposed on opposed sides of the fifth center robot CR5. The fifth center robot CR5 has a pair of hands CRH7 and CRH8 arranged vertically for transferring a substrate W.

A partition 23 for closing off the communication of atmosphere is provided between the development processing block 12 and the resist cover film processing block 13. The partition 23 is provided with a pair of substrate rest parts PASS7 and PASS8 arranged vertically in proximity to each other and each for transferring a substrate W between the development processing block 12 and the resist cover film processing block 13. The upper substrate rest part PASS7 is used for the transport of a substrate W from the development processing block 12 to the resist cover film processing block 13. The lower substrate rest part PASS8, on the other hand, is used for the transport of a substrate W from the resist cover film processing block 13 to the development processing block 12.

The resist cover film removal block 14 includes resist cover film removal processing parts 70a and 70b, and a sixth center robot CR6. The resist cover film removal processing parts 70a and 70b are disposed on opposed sides of the sixth center robot CR6. The sixth center robot CR6 has a pair of hands CRH9 and CRH10 arranged vertically for transferring a substrate W.

A partition 24 for closing off the communication of atmosphere is provided between the resist cover film processing block 13 and the resist cover film removal block 14. The partition 24 is provided with a pair of substrate rest parts PASS9 and PASS10 arranged vertically in proximity to each other and each for transferring a substrate W between the resist cover film processing block 13 and the resist cover film removal block 14. The upper substrate rest part PASS9 is used for the transport of a substrate W from the resist cover film processing block 13 to the resist cover film removal block 14. The lower substrate rest part PASS10, on the other hand, is used for the transport of a substrate W from the resist cover film removal block 14 to the resist cover film processing block 13.

The cleaning/drying processing block 15 includes post-exposure bake heat treatment parts 150 and 151, a cleaning/drying processing part 80, and a seventh center robot CR7. The post-exposure bake heat treatment part 151 is adjacent to the interface block 16, and includes substrate rest parts PASS13 and PASS14 which will be described later. The post-exposure bake heat treatment parts 150 and 151 and the cleaning/drying processing part 80 are disposed on opposed sides of the seventh center robot CR7. The seventh center robot CR7 has a pair of hands CRH11 and CRH12 arranged vertically for transferring a substrate W.

A partition 25 for closing off the communication of atmosphere is provided between the resist cover film removal block 14 and the cleaning/drying processing block 15. The partition 25 is provided with a pair of substrate rest parts PASS11 and PASS12 arranged vertically in proximity to each other and each for transferring a substrate W between the resist cover film removal block 14 and the cleaning/drying processing block 15. The upper substrate rest part PASS11 is used for the transport of a substrate W from the resist cover film removal block 14 to the cleaning/drying processing block 15. The lower substrate rest part PASS12, on the other hand, is used for the transport of a substrate W from the cleaning/drying processing block 15 to the resist cover film removal block 14.

The interface block 16 includes an eighth center robot CR8, a send buffer part SBF, an interface transport mechanism IFR, and two edge exposure parts EEW. Substrate rest parts PASS15 and PASS16 and a return buffer part RBF which will be described later are provided under the edge exposure parts EEW. The eighth center robot CR8 has a pair of hands CRH13 and CRH14 arranged vertically for transferring a substrate W. The interface transport mechanism IFR has a pair of hands IFRH1 and IFRH2 arranged vertically for transferring a substrate W.

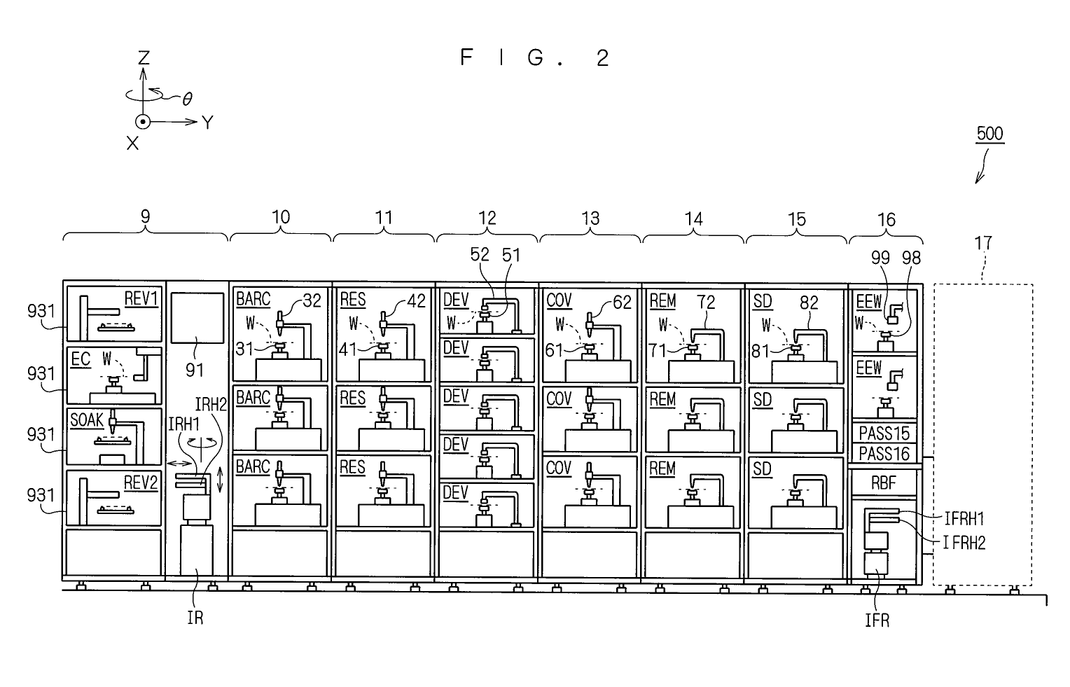

FIG. 2 is a side view of the substrate processing apparatus 500 of FIG. 1 as viewed from the (+X) side. The cleaning processing part 93 (see FIG. 1) in the indexer block 9 includes one or more processing units 931 (an edge cleaning processing unit EC, a pair of inverting units REV1 and REV2, and a back surface cleaning unit SOAK) which are arranged in vertically stacked relation. The specific construction of each of the processing units 931 will be described later.

The anti-reflection film coating processing part 30 (see FIG. 1) in the anti-reflection film processing block 10 includes three coating units BARC arranged in vertically stacked relation. Each of the coating units BARC includes a spin chuck 31 for rotating while holding a substrate W in a horizontal position under suction, a supply nozzle 32 for supplying a coating solution for an anti-reflection film to the substrate W held on the spin chuck 31, and a removal nozzle (not shown) for removing the anti-reflection film formed on a peripheral portion of the substrate W.

The resist film coating processing part 40 (see FIG. 1) in the resist film processing block 11 includes three coating units RES arranged in vertically stacked relation. Each of the coating units RES includes a spin chuck 41 for rotating while holding a substrate W in a horizontal position under suction, a supply nozzle 42 for supplying a coating solution for a resist film to the substrate W held on the spin chuck 41, and a removal nozzle (not shown) for removing the resist film formed on a peripheral portion of the substrate W.

The development processing part 50 (see FIG. 1) in the development processing block 12 includes five development processing units DEV arranged in vertically stacked relation. Each of the development processing units DEV includes a spin chuck 51 for rotating while holding a substrate W in a horizontal position under suction, and a supply nozzle 52 for supplying a developing solution to the substrate W held on the spin chuck 51.

The resist cover film coating processing part 60 (see FIG. 1) in the resist cover film processing block 13 includes three coating units COV arranged in vertically stacked relation. Each of the coating units COV includes a spin chuck 61 for rotating while holding a substrate W in a horizontal position under suction, a supply nozzle 62 for supplying a coating solution for a resist cover film to the substrate W held on the spin chuck 61, and a removal nozzle 63 (not shown) for removing the resist cover film formed on a peripheral portion of the substrate W.

The resist cover film removal processing part 70b (see FIG. 1) in the resist cover film removal block 14 includes three removal units REM arranged in vertically stacked relation. Each of the removal units REM includes a spin chuck 71 for rotating while holding a substrate W in a horizontal position under suction, and a supply nozzle 72 for supplying a removal solution (e.g., fluororesin) for dissolving the resist cover film to the substrate W held on the spin chuck 71.

The cleaning/drying processing part 80 (see FIG. 1) in the cleaning/drying processing block 15 includes three cleaning/drying processing units SD arranged in vertically stacked relation. Each of the cleaning/drying processing units SD includes a spin chuck 81 for rotating while holding a substrate W in a horizontal position under suction, and a supply nozzle 82 for supplying a cleaning liquid (e.g., deionized water) to the substrate W held on the spin chuck 81.

In the interface block 16, the two edge exposure parts EEW, the substrate rest parts PASS15 and PASS16, and the return buffer part RBF are arranged in vertically stacked relation. Additionally, the eighth center robot CR8 (see FIG. 1) and the interface transport mechanism IFR are disposed in the interface block 16. Each of the edge exposure parts EEW includes a spin chuck 98 for rotating while holding a substrate W in a horizontal position under suction, and a light irradiator 99 for exposing the periphery of the substrate W held on the spin chuck 98 to light.

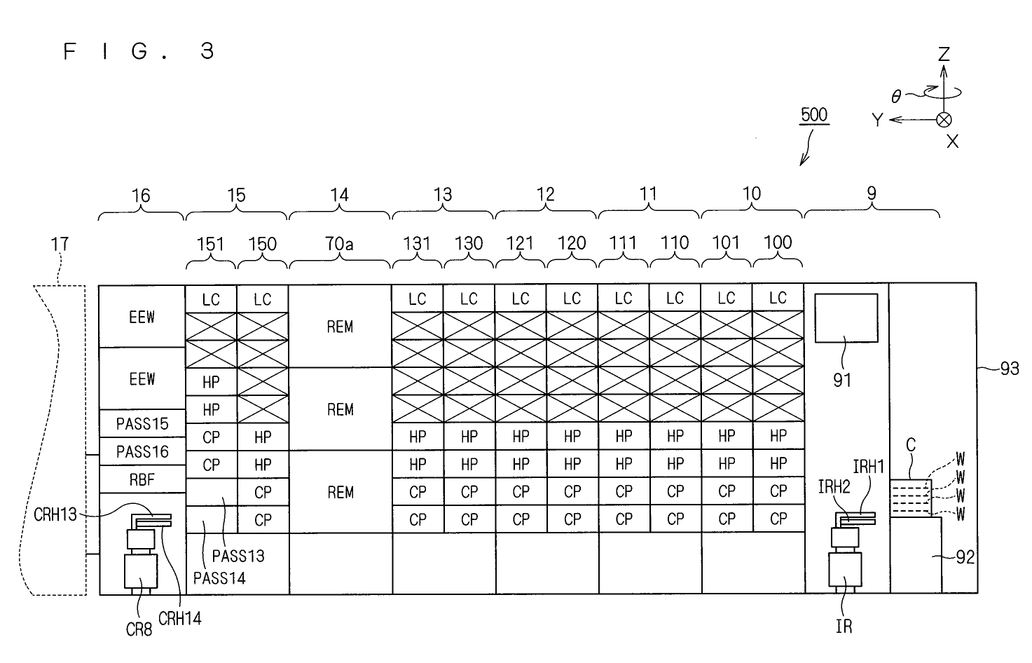

FIG. 3 is a side view of the substrate processing apparatus 500 of FIG. 1 as viewed from the (−X) side.

Each of the anti-reflection film heat treatment parts 100 and 101 in the anti-reflection film processing block 10 includes two heating units (hot plates) HP and two cooling units (cooling plates) CP which are arranged in vertically stacked relation. A local controller LC for controlling the temperatures of the cooling units CP and the heating units HP is disposed in the topmost tier of each of the anti-reflection film heat treatment parts 100 and 101.

Each of the resist film heat treatment parts 110 and 111 in the resist film processing block 11 includes two heating units HP and two cooling units CP which are arranged in vertically stacked relation. A local controller LC for controlling the temperatures of the cooling units CP and the heating units HP is disposed in the topmost tier of each of the resist film heat treatment parts 110 and 111.

Each of the development heat treatment parts 120 and 121 in the development processing block 12 includes two heating units HP and two cooling units CP which are arranged in vertically stacked relation. A local controller LC for controlling the temperatures of the cooling units CP and the heating units HP is disposed in the topmost tier of each of the development heat treatment parts 120 and 121.

Each of the resist cover film heat treatment parts 130 and 131 in the resist cover film processing block 13 includes two heating units HP and two cooling units CP which are arranged in vertically stacked relation. A local controller LC for controlling the temperatures of the cooling units CP and the heating units HP is disposed in the topmost tier of each of the resist cover film heat treatment parts 130 and 131.

The resist cover film removal processing part 70a in the resist cover film removal block 14 includes three removal units REM arranged in vertically stacked relation.

Each of the post-exposure bake heat treatment parts 150 and 151 in the cleaning/drying processing block 15 includes two heating units HP and two cooling units CP which are arranged in vertically stacked relation. The substrate rest parts PASS13 and PASS14 are also disposed in the post-exposure bake heat treatment part 151. A local controller LC for controlling the temperatures of the cooling units CP and the heating units HP is disposed in the topmost tier of each of the post-exposure bake heat treatment parts 150 and 151.

The numbers of coating units BARC, RES and COV, the number of cleaning/drying processing units SD, the number of removal units REM, the number of development processing units DEV, the number of heating units HP, and the number of cooling units CP may be changed as appropriate in accordance with the processing speed of the corresponding blocks.

2. Operation of Substrate Processing Apparatus 500

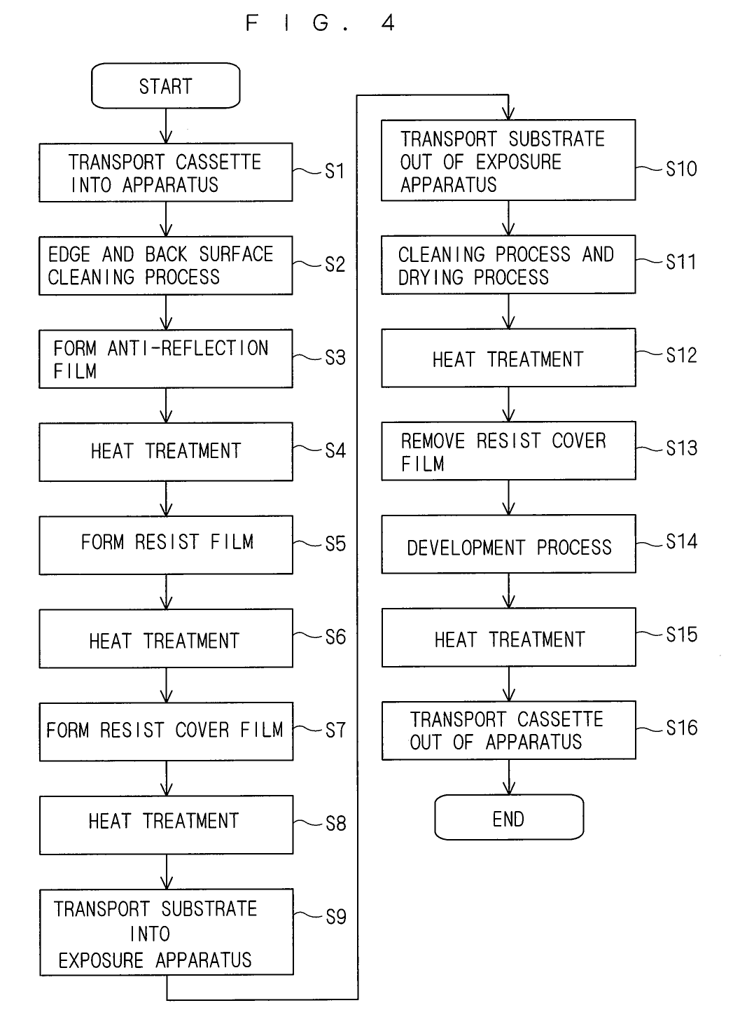

Next, the processing operation of the substrate processing apparatus 500 will be described with reference to FIGS. 1 to 3 and FIG. 4. FIG. 4 is a flow diagram showing the operation of the substrate processing apparatus 500. The controller 91 controls the operations of the respective components to be described below.

For the processing of a substrate W in this substrate processing apparatus 500, the first step is to transport a cassette (carrier) C which stores a plurality of substrates W in tiers onto the cassette table 92 (or one of the cassette tables 92) in the indexer block 9 (in Step S1).

After the cassette C is placed on the cassette table 92 (or one of the cassette tables 92), the indexer robot IR uses the pre-cleaning hand IRH1 to take an unprocessed substrate W out of the cassette C. Then, the indexer robot IR moves in a direction of the X-axis to transport the unprocessed substrate W to the cleaning processing part 93. The cleaning processing part 93 performs the process of cleaning an edge and a back surface of the substrate W (in Step S2). This process will be described later. The term “edge” used herein refers to a side surface of a substrate W and annular regions of upper and lower surfaces of the substrate W which lie within the range of 3 to 4 mm from the periphery thereof.

After the process of cleaning the edge and the back surface, the indexer robot IR uses the post-cleaning hand IRH2 to take the substrate W from the cleaning processing part 93, rotates in a direction θ while moving in a direction of the X axis, and places the substrate W onto the substrate rest part PASS1.

The second center robot CR2 in the anti-reflection film processing block 10 receives the substrate W placed on the substrate rest part PASS1, and transports the substrate to the coating units BARC in the anti-reflection film coating processing part 30. In the coating units BARC, an anti-reflection film for reducing standing waves or halation occurring during exposure is formed by coating on an upper surface of the substrate W (in Step S3). Part of the anti-reflection film formed in a region of a predetermined width from the periphery of the substrate W is removed by a removal solution discharged from the removal nozzle in the coating units BARC.

Thereafter, the second center robot CR2 takes the substrate W from the anti-reflection film coating processing part 30, and transports the substrate W into the anti-reflection film heat treatment parts 100 and 101. In the anti-reflection film heat treatment parts 100 and 101, a predetermined heat treatment (a heating process and a cooling process) is performed on the substrate W (in Step S4). After the heat treatment in the anti-reflection film heat treatment parts 100 and 101, the second center robot CR2 takes the substrate W from the anti-reflection film heat treatment parts 100 and 101, and places the substrate W onto the substrate rest part PASS3.

The third center robot CR3 in the resist film processing block 11 receives the substrate W placed on the substrate rest part PASS3, and transports the substrate W to the coating units RES in the resist film coating processing part 40. In the coating units RES, a resist film is formed by coating over the anti-reflection film on the upper surface of the substrate W (in Step S5). Part of the resist film formed in a region of a predetermined width from the periphery of the substrate W is removed by a removal solution discharged from the removal nozzle in the coating units RES.

Thereafter, the third center robot CR3 takes the substrate W from the resist film coating processing part 40, and transports the substrate W into the resist film heat treatment parts 110 and 111. In the resist film heat treatment parts 110 and 111, a predetermined heat treatment (a heating process and a cooling process) is performed on the substrate W (in Step S6). After the heat treatment in the resist film heat treatment parts 110 and 111, the third center robot CR3 takes the substrate W from the resist film heat treatment parts 110 and 111, and places the substrate W onto the substrate rest part PASS5.

The fourth center robot CR4 in the development processing block 12 receives the substrate W placed on the substrate rest part PASS5, and places the substrate W onto the substrate rest part PASS7.

The fifth center robot CR5 in the resist cover film processing block 13 receives the substrate W placed on the substrate rest part PASS7, and transports the substrate W to the coating units COV in the resist cover film coating processing part 60. In the coating units COV, a resist cover film is formed by coating over the resist film on the upper surface of the substrate W (in Step S7). Part of the resist cover film formed in a region of a predetermined width from the periphery of the substrate W is removed by a removal solution discharged from the removal nozzle in the coating units COV.

Thereafter, the fifth center robot CR5 takes the substrate W from the resist cover film coating processing part 60, and transports the substrate W into the resist cover film heat treatment parts 130 and 131. In the resist cover film heat treatment parts 130 and 131, a predetermined heat treatment (a heating process and a cooling process) is performed on the substrate W (in Step S8). After the heat treatment in the resist cover film heat treatment parts 130 and 131, the fifth center robot CR5 takes the substrate W from the resist cover film heat treatment parts 130 and 131, and places the substrate W onto the substrate rest part PASS9.

The sixth center robot CR6 in the resist cover film removal block 14 receives the substrate W placed on the substrate rest part PASS9, and places the substrate W onto the substrate rest part PASS11. The seventh center robot CR7 in the cleaning/drying processing block 15 receives the substrate W placed on the substrate rest part PASS11, and places the substrate W onto the substrate rest part PASS13. The eighth center robot CR8 in the interface block 16 receives the substrate W placed on the substrate rest part PASS13, and places the substrate W onto the substrate rest part PASS15. In the interface block 16, the substrate W may be transported into the edge exposure parts EEW so that an exposure process is performed on a peripheral portion of the substrate W.

The interface transport mechanism IFR in the interface block 16 transports the substrate W from the substrate rest part PASS15 into a substrate loading part 17a in the exposure apparatus 17 (in Step S9). If the exposure apparatus 17 is unable to accept the substrate W, the send buffer part SBF temporarily stores the substrate W. The exposure apparatus 17 performs an immersion exposure process on the substrate W to form a predetermined electronic pattern on the upper surface of the substrate W.

Thereafter, the interface transport mechanism IFR in the interface block 16 takes the substrate W subjected to the exposure process from a substrate unloading part 17b in the exposure apparatus 17 (in Step S10), and transports the substrate W into the cleaning/drying processing part 80 in the cleaning/drying processing block 15. If the cleaning/drying processing part 80 is unable to accept the substrate W, the return buffer part RBF temporarily stores the substrate W. In the cleaning/drying processing units SD in the cleaning/drying processing part 80, a cleaning process and a drying process is performed on the substrate W subjected to the exposure process (in Step S11).

After the cleaning process and the drying process in the cleaning/drying processing part 80, the interface transport mechanism IFR in the interface block 16 takes the substrate W from the cleaning/drying processing part 80, and places the substrate W onto the substrate rest part PASS16.

The eighth center robot CR8 in the interface block 16 receives the substrate W placed on the substrate rest part PASS16, and transports the substrate W to the post-exposure bake heat treatment parts 150 and 151 in the cleaning/drying processing block 15. In the post-exposure bake heat treatment parts 150 and 151, a predetermined heat treatment (a heating process and a cooling process) is performed on the substrate W subjected to the exposure process (in Step S12). After the heat treatment in the post-exposure bake heat treatment parts 150 and 151, the eighth center robot CR8 in the interface block 16 takes the substrate W from the post-exposure bake heat treatment parts 150 and 151, and places the substrate W onto the substrate rest part PASS14. The seventh center robot CR7 in the cleaning/drying processing block 15 receives the substrate W placed on the substrate rest part PASS14, and places the substrate W onto the substrate rest part PASS12.

The sixth center robot CR6 in the resist cover film removal block 14 receives the substrate W placed on the substrate rest part PASS12, and transports the substrate W into the removal units REM in the resist cover film removal processing parts 70a and 70b. In the removal units REM, a predetermined removal solution is used to remove the resist cover film from the upper surface of the substrate W (in Step S13).

Thereafter, the sixth center robot CR6 takes the substrate W from the resist cover film removal processing parts 70a and 70b, and places the substrate W onto the substrate rest part PASS10. The fifth center robot CR5 in the resist cover film processing block 13 receives the substrate placed on the substrate rest part PASS10, and places the substrate W onto the substrate rest part PASS8.

The fourth center robot CR4 in the development processing block 12 receives the substrate W placed on the substrate rest part PASS8, and transports the substrate W into the development processing units DEV in the development processing part 50. In the development processing units DEV, a development process is performed by supplying a developing solution to the upper surface of the substrate W (in Step S14).

Thereafter, the fourth center robot CR4 takes the substrate W from the development processing part 50, and transports the substrate W into the development heat treatment parts 120 and 121. In the development heat treatment parts 120 and 121, a predetermined heat treatment (a heating process and a cooling process) is performed on the substrate W (in Step S15). After the heat treatment in the development heat treatment parts 120 and 121, the fourth center robot CR4 takes the substrate W from the development heat treatment parts 120 and 121, and places the substrate W onto the substrate rest part PASS6.

The third center robot CR3 in the resist film processing block 11 receives the substrate W placed on the substrate rest part PASS6, and places the substrate W onto the substrate rest part PASS4. The second center robot CR2 in the anti-reflection film processing block 10 receives the substrate W placed on the substrate rest part PASS4, and places the substrate W onto the substrate rest part PASS2. The indexer robot IR in the indexer block 9 uses the post-cleaning hand IRH2 to receive the substrate W placed on the substrate rest part PASS2 and to store the substrate W into a cassette C on the cassette table 92 (or one of the cassette tables 92). Thereafter, the cassette C is transported from the cassette table 92 to the outside of the substrate processing apparatus 500 (in Step S16). Thus, a series of processes of the substrate W in the substrate processing apparatus 500 is completed.

3. Layout of Indexer Block 9

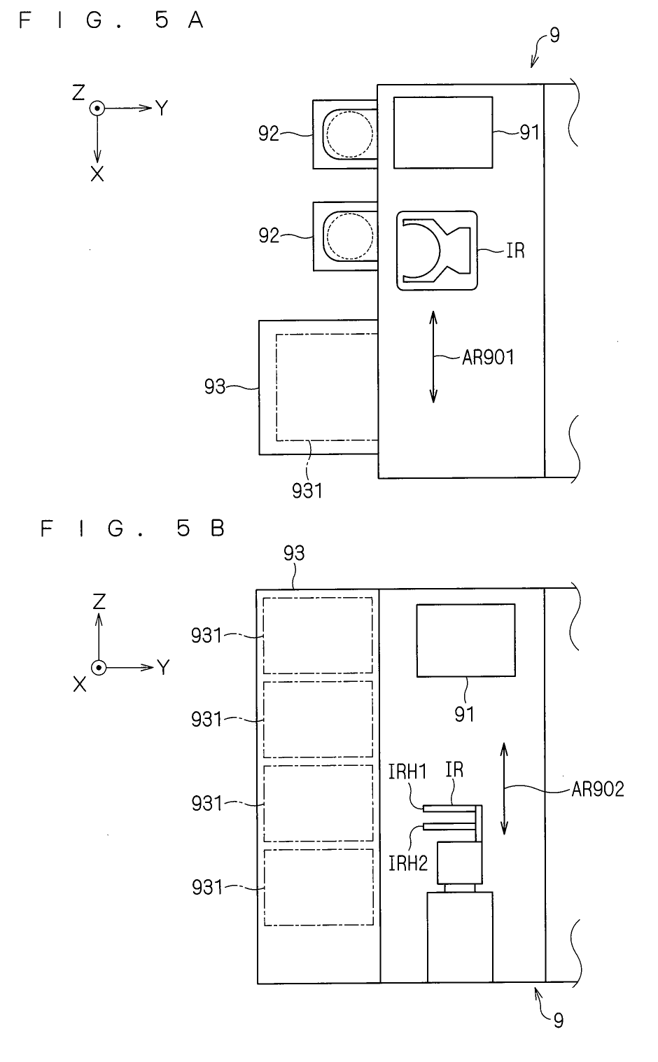

Next, the construction of the indexer block 9 will be described in further detail. As mentioned above, the indexer block 9 includes the controller 91, the one or more cassette tables 92, the cleaning processing part 93 provided with the one or more processing units 931, and the indexer robot IR. The arrangement of these components will be described with reference to FIGS. 5A and 5B. FIGS. 5A and 5B are a plan view and a side view, respectively, showing an example of the layout of the indexer block 9.

The cleaning processing part 93 is disposed adjacent to the one or more cassette tables 92. The indexer robot IR is capable of moving in the X direction (as indicated by the arrow AR901) to gain access to any one of the cassette tables 92 and the cleaning processing part 93.

The one or more (in FIG. 5B, four) processing units 931 provided in the cleaning processing part 93 are disposed in stacked relation. The indexer robot IR is capable of being extended and retracted in the Z direction (as indicated by the arrow AR902) to gain access to any one of the processing units 931.

Although the cleaning processing part 93 is composed of the four processing units 931 in this embodiment, it is not always necessary for the cleaning processing part 93 to be composed of the four processing units 931. This will be described as a modification later.

4. Construction of Cleaning Processing Part 93

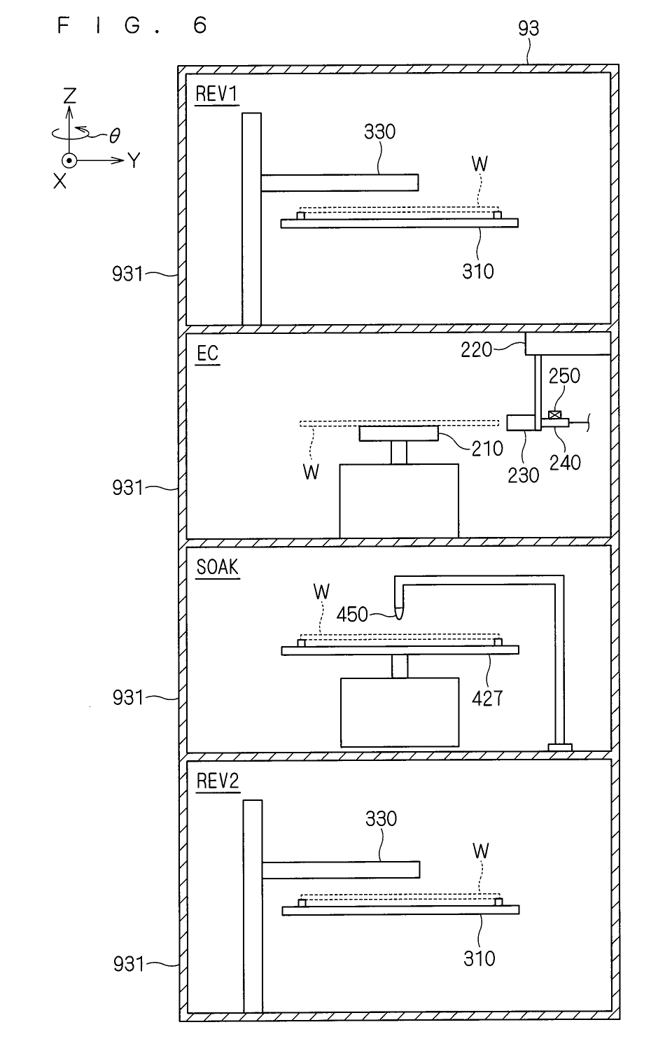

Next, the construction of the cleaning processing part 93 will be described in further detail. As mentioned above, the cleaning processing part 93 includes the edge cleaning processing unit EC, the back surface cleaning unit SOAK, and the pair of inverting units REV1 and REV2 as the processing units 931. As shown in FIG. 6, the processing units 931 are arranged in vertically stacked relation, for example, from top to bottom in the following order: the first inverting unit REV1, the edge cleaning processing unit EC, the back surface cleaning unit SOAK and the second inverting unit REV2. The order in which the processing units 931 are arranged in stacked relation is not limited to this. For example, the processing units 931 may be arranged in vertically stacked relation from top to bottom in the following order: the edge cleaning processing unit EC, the first inverting unit REV1, the back surface cleaning unit SOAK and the second inverting unit REV2.

Next, each of the units will be described in further detail. The first and second inverting units REV1 and REV2 are collectively referred to as an “inverting unit REV,” unless otherwise identified.

4-1. Edge Cleaning Processing Unit EC

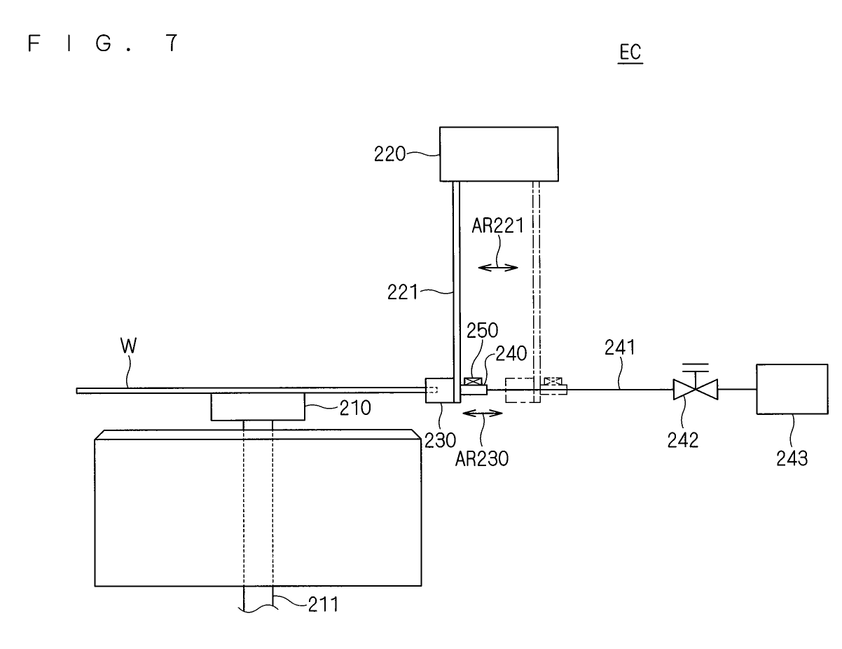

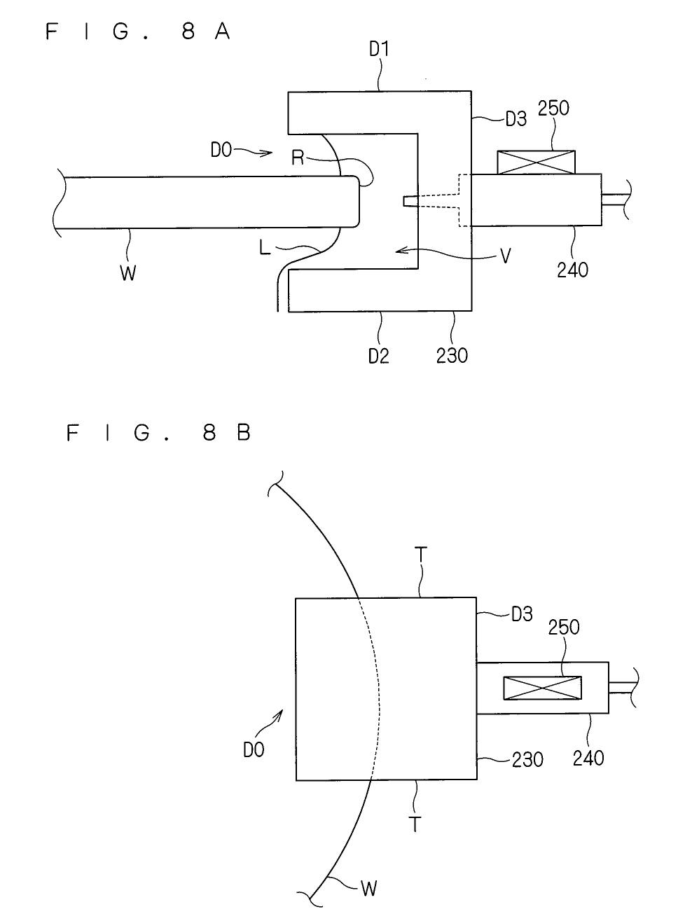

The edge cleaning processing unit EC will be described with reference to FIGS. 7, 8A and 8B. FIG. 7 is a view showing the overall construction of the edge cleaning processing unit EC. FIGS. 8A and 8b are a side view and a plan view, respectively, showing a nozzle portion. The edge cleaning processing unit EC principally includes a spin chuck 210, a nozzle movement mechanism 220, an inclined U-shaped nozzle 230, and an ultrasonic nozzle 240.

The spin chuck 210 rotates a substrate W about a vertical rotation axis passing through the center of the substrate W while holding the substrate W in a horizontal position. The spin chuck 210 is fixed on the upper end of a rotary shaft 211 rotated by an electric motor not shown. The spin chuck 210 is formed with a suction passage (not shown). With the substrate W placed on the spin chuck 210, air is exhausted from the suction passage, whereby the lower surface of the substrate W is vacuum-held on the spin chuck 210, and the substrate W is held in a horizontal position.

The nozzle movement mechanism 220 is disposed on one side of the spin chuck 210 in an upper portion of the edge cleaning processing unit EC. A rodlike nozzle support member 221 extending downwardly is mounted to the nozzle movement mechanism 220. The nozzle support member 221 is movable in a horizontal direction (as indicated by the arrow AR221) by controlling the driving of the nozzle movement mechanism 220.

The inclined U-shaped nozzle 230 is mounted to the lower end of the nozzle support member 221, and is approximately level with the substrate W held by the spin chuck 210. The nozzle movement mechanism 220 is drive-controlled to move the nozzle support member 221 in a horizontal direction, thereby moving the inclined U-shaped nozzle 230 in a horizontal direction (as indicated by the arrow AR230). During the edge cleaning process of the substrate W, the inclined U-shaped nozzle 230 is placed in a processing position (indicated by the solid lines of FIG. 7) that is the position of the edge of the objective substrate W held by the spin chuck 210. After the edge cleaning process, the inclined U-shaped nozzle 230 is placed in a retracted position (indicated by the phantom lines of FIG. 7) distant from the position of the edge of the objective substrate W.

As shown in FIG. 8A, the inclined U-shaped nozzle 230 is of an inclined U-shaped cross-sectional configuration such that opposite horizontal end portions T thereof are open. The inclined U-shaped nozzle 230 has an inclined U-shaped open surface D0 opposed to the side surface of substrate W held by the spin chuck 210. Specifically, when the inclined U-shaped nozzle 230 is placed in the processing position, the edge R of the objective substrate W is inserted between upper and lower surfaces D1 and D2 of the inclined U-shaped nozzle 230 so that the edge R is positioned in an interior space V of the inclined U-shaped nozzle 230.

The ultrasonic nozzle 240 is mounted to the inclined U-shaped nozzle 230 in such a manner as to extend through the rear surface D3 of the inclined U-shaped nozzle 230. A cleaning liquid supply pipe 241 has a first end connected to the ultrasonic nozzle 240. The cleaning liquid supply pipe 241 has a second end connected through an on-off valve 242 to a cleaning liquid supply source 243. Examples of the cleaning liquid used herein include deionized water, a solution of a complex (ionized) in deionized water, a fluorine-based chemical solution, and the like. When the on-off valve 242 is opened, the cleaning liquid is supplied through the cleaning liquid supply pipe 241 to the ultrasonic nozzle 240, which in turn discharges the cleaning liquid into the interior space V of the inclined U-shaped nozzle 230.

A high-frequency vibrator 250 is mounted to the ultrasonic nozzle 240. The high-frequency vibrator 250 is connected to a high-frequency generating device (not shown). When a high-frequency current is supplied from the high-frequency generating device to the high-frequency vibrator 250, the high-frequency vibrator 250 ultrasonically vibrates. Thus, a high-frequency output corresponding to the value of the high-frequency current is applied to the cleaning liquid flowing through the ultrasonic nozzle 240. In other words, the ultrasonically vibrated cleaning liquid is discharged from the ultrasonic nozzle 240. The high-frequency output applied to the cleaning liquid is determined as appropriately in accordance with the type of the substrate, cleaning conditions and the like.

When the ultrasonically vibrated cleaning liquid is discharged from the ultrasonic nozzle 240 into the interior space V of the inclined U-shaped nozzle 230, a puddle L of cleaning liquid is formed in the interior space V of the inclined U-shaped nozzle 230 by the interfacial tension between the discharged cleaning liquid and the inner peripheral wall portion of the inclined U-shaped nozzle 230, as shown in FIG. 8A, and the edge R of the objective substrate W positioned in the interior space V is immersed in the puddle L. Then, upon receiving the impact of the high-frequency vibration, particles deposited on the edge R are released from the surface of the substrate W. That is, the edge R is cleaned.

4-2. Inverting Unit REV

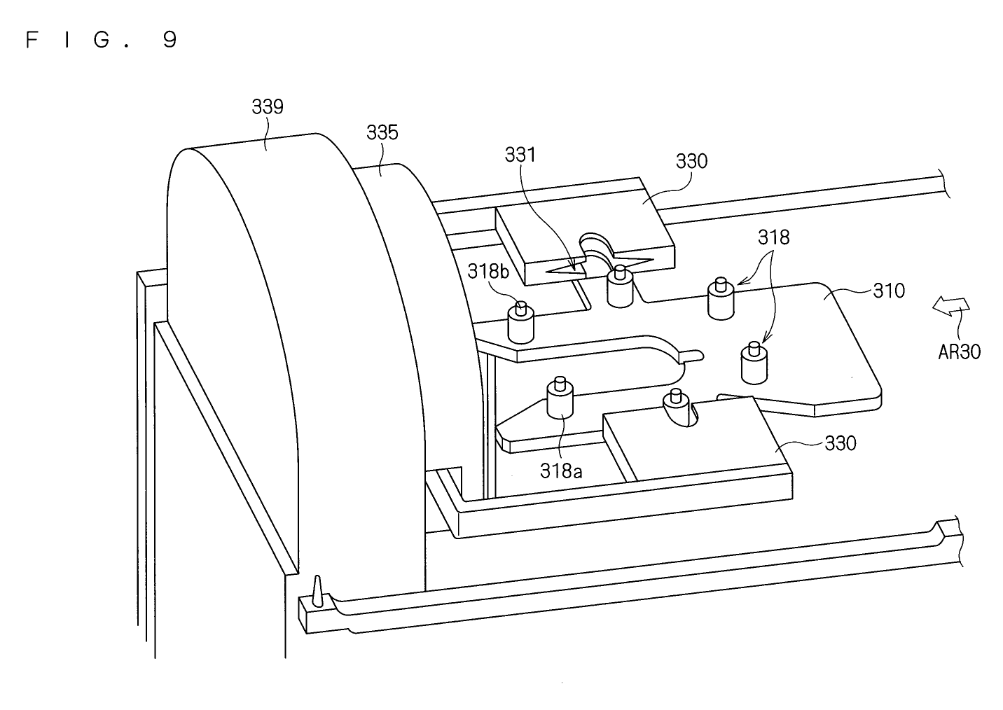

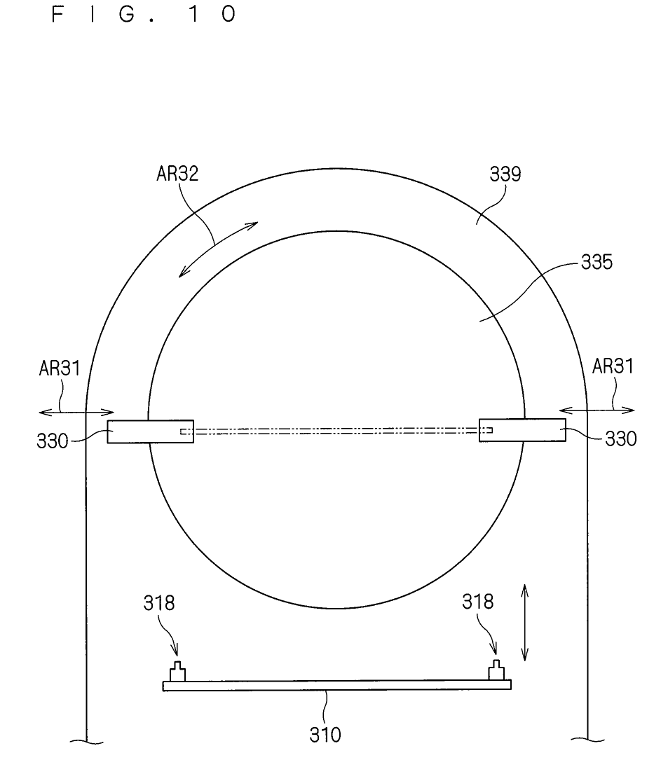

Next, the inverting unit REV will be described with reference to FIGS. 9 and 10. FIG. 9 is a perspective view showing the construction of major parts of the inverting unit REV. FIG. 10 is a schematic front view of the inverting unit REV as seen in the direction of the arrow AR30 of FIG. 9. The inverting unit REV is a unit for inverting or flipping a substrate W upside down and vice versa. The inverting unit REV principally includes a lifting table 310 and a pair of inverting chucks 330.

The lifting table 310 is movable upwardly and downwardly in a vertical direction by a lifting drive mechanism (not shown) constructed using, for example, an air cylinder. A plurality of (in this embodiment, six) support pins 318 mounted upright are disposed concyclically (or on the same circumference) on the upper surface of the lifting table 310. Each of the support pins 318 includes a support portion 318a for supporting a peripheral portion of the lower surface of a substrate W from below, and a pin portion 318b projecting from the upper surface of the support portion 318a. All of the six support pins 318 are fixed on the lifting table 310 because the lifting table 310 of the inverting unit REV does not serve to rotate the substrate W unlike a spin chuck 427 of the back surface cleaning unit SOAK but there is little need for the lifting table 310 to rigidly hold the substrate W. That is, the pin portions 318b of the lifting table 310 are members for merely restricting the horizontal position of the substrate W.

The pair of right-hand and left-hand inverting chucks 330 are disposed diametrically of a disc-shaped rotary base 335. The inverting chucks 330 are slidably moved as indicated by the arrow AR31 of FIG. 10 by a sliding drive mechanism incorporated in the rotary base 335. The pair of inverting chucks 330 slidably move in cooperation with each other to increase and decrease a distance therebetween. Each of the inverting chucks 330 includes a grasping portion 331 which is an opening for grasping an edge portion of a substrate W. With a substrate W held at the same vertical position as the inverting chucks 330 by the lifting table 310, the pair of inverting chucks 330 slidably move in such a manner as to decrease the spacing therebetween, whereby the grasping portions 331 grasp the edge portion of the substrate W. Each of the grasping portions 331 is notched to avoid the interference of the lifting table 310 with the support pins 318.

The rotary base 335 is rotatable in a vertical plane by a rotatable drive mechanism provided in a unit base 339 as indicated by the arrow AR32 of FIG. 10. The rotation of the rotary base 335 causes the pair of inverting chucks 330 to rotate in a direction indicated by the arrow AR32.

The inverting unit REV inverts or flips a substrate W upside down and vice versa in a manner to be described below. First, the lifting table 310 moves upwardly to a transport position which is above the inverting chucks 330. After receiving a substrate W onto the support pins 318 in the transport position, the lifting table 310 moves downwardly to a transfer position in which the substrate W is transferred to and from the inverting chucks 330. The transfer position is a position in which the inverting chucks 330 remaining stationary in horizontally opposed relation with each other is level with the substrate W held by the lifting table 310. When the lifting table 310 moves downwardly to the transfer position, the pair of inverting chucks 330 are moved so that the spacing between the inverting chucks 330 allows the substrate W to pass therebetween.

With the lifting table 310 moved downwardly to the transfer position, the pair of inverting chucks 330 start slidably moving so as to decrease the spacing therebetween. In due course, the grasping portions 331 of the pair of inverting chucks 330 grasp the edge portion of the substrate W. Thus, the substrate W is held by the inverting chucks 330, and the lifting table 310 moves further downwardly to a retracted position which is below the transfer position. The retracted position is a position in which no collision occurs between the inverting chucks 330 and the lifting table 310 in the subsequent inverting step.

Next, the rotary base 335 rotates 180 degrees (or makes a half turn) to invert or flip the substrate W upside down. Thereafter, the lifting table 310 moves upwardly from the retracted position to the transfer position, and receives the substrate W onto the support pins 318, whereas the pair of inverting chucks 330 slidably move so as to increase the spacing therebetween. After receiving the inverted substrate W, the lifting table 310 moves further upwardly to the above-mentioned transport position. In the transport position, the inverted substrate W is transported outwardly from the support pins 318. The support pins 318 do not damage a pattern formed on the front surface of the substrate W if the patterned front surface of the substrate W is positioned to face downward by the inverting process because the support pins 318 support the edge portion of the substrate W.

4-3. Back Surface Cleaning Unit SOAK

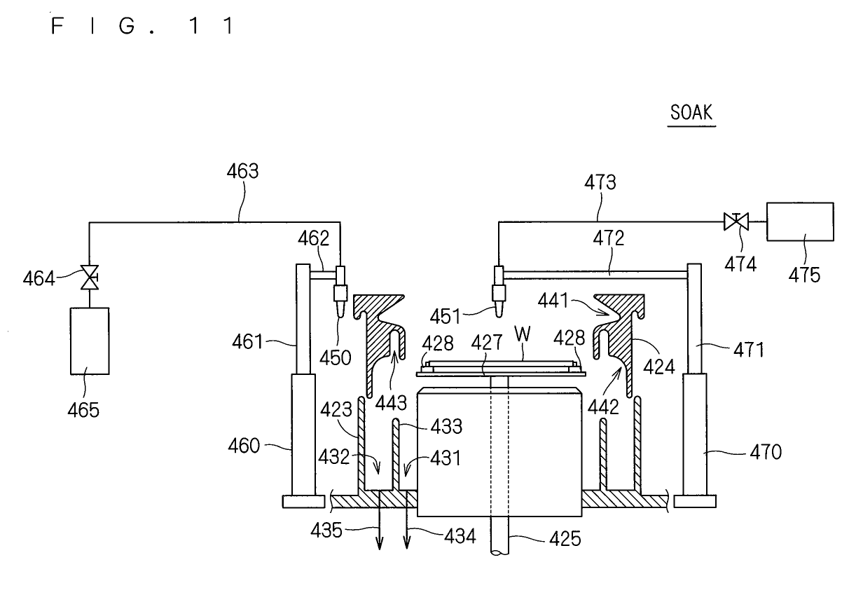

Next, the back surface cleaning unit SOAK will be described with reference to FIG. 11. FIG. 11 is a view showing the construction of the back surface cleaning unit SOAK. The back surface cleaning unit SOAK principally includes a spin chuck 427, a cleaning nozzle pivoting mechanism 460, a cleaning nozzle 450, a drying nozzle pivoting mechanism 470, and a drying nozzle 451.

Like the above-mentioned spin chuck 210 in the edge cleaning processing unit EC, the spin chuck 427 rotates a substrate W about a vertical rotation axis passing through the center of the substrate W while holding the substrate W in a horizontal position. Although the spin chuck 210 in the edge cleaning processing unit EC is of the type which holds the lower surface of the substrate W under vacuum suction, the spin chuck 427 in the back surface cleaning unit SOAK is of the type which grasps the edge portion of the substrate W. Specifically, a plurality of (in this embodiment, six) support pins 428 mounted upright are disposed concyclically (or on the same circumference) on a peripheral portion of the upper surface of the spin chuck 427. Each of the support pins 428 includes a cylindrical support portion for supporting a peripheral portion of the lower surface of the substrate W from below, and a pin portion projecting from the upper surface of the support portion and for abutting against and pressing the edge portion of the substrate W. Three of the six support pins 428 are fixed support pins fixedly provided on the spin chuck 427. Each of the fixed support pins is configured such that the projecting pin portion is provided on the axis of the cylindrical support portion. The remaining three of the six support pins are movable support pins provided rotatably (on their axes) relative to the spin chuck 427. Each of the movable support pins is configured such that the projecting pin portion is provided slightly eccentrically with respect to the axis of the cylindrical support portion. The three movable support pins are pivotably driven in cooperation with each other by a linkage mechanism and a drive mechanism both not shown. The pivotal movement of the movable support pins allows the six pin portions to grasp the edge portion of the substrate W and to release the grasp of the substrate W. The six support pins 428 grasp the edge portion of the substrate W to thereby allow the spin chuck 427 to hold the substrate W without contacting the central portion of the lower surface of the substrate W.

The cleaning nozzle pivoting mechanism 460 includes, for example, a pivot motor, and is disposed on one side of the spin chuck 427. A pivoting shaft 461 extending upwardly is connected to the cleaning nozzle pivoting mechanism 460. An arm 462 extending in a horizontal direction is coupled to the pivoting shaft 461. The cleaning nozzle pivoting mechanism 460 is drive-controlled to thereby pivot the arm 462.

The cleaning nozzle 450 is mounted to the tip of the arm 462. The cleaning nozzle pivoting mechanism 460 is drive-controlled to pivot the arm 462, thereby moving the cleaning nozzle 450 to over the substrate W held by the spin chuck 427. During the execution of the back surface cleaning process of the substrate W, the cleaning nozzle 450 is placed in a processing position lying over the objective substrate W held by the spin chuck 427. After the back surface cleaning process, the cleaning nozzle 450 is placed in a retracted position (the position shown in FIG. 11) distant from the objective substrate W.

A cleaning liquid supply pipe 463 has a first end connected to the cleaning nozzle 450. The cleaning liquid supply pipe 463 has a second end connected through an on-off valve 464 to a cleaning liquid supply source 465. When the on-off valve 464 is opened, the cleaning liquid is supplied through the cleaning liquid supply pipe 463 to the cleaning nozzle 450. This allows the cleaning liquid to be fed from the cleaning nozzle 450 to the back surface of the substrate W. The cleaning nozzle 450 used herein may be what is called a straight nozzle for directly discharging a cleaning liquid fed thereto.

The drying nozzle pivoting mechanism 470 includes, for example, a pivot motor, and is disposed on the opposite side of the spin chuck 427 from the cleaning nozzle pivoting mechanism 460. A pivoting shaft 471 extending upwardly is connected to the drying nozzle pivoting mechanism 470. An arm 472 extending in a horizontal direction is coupled to the pivoting shaft 471. The drying nozzle pivoting mechanism 470 is drive-controlled to thereby pivot the arm 472.

The drying nozzle 451 is mounted to the tip of the arm 472. The drying nozzle pivoting mechanism 470 is drive-controlled to pivot the arm 472, thereby moving the drying nozzle 451 to over the substrate W held by the spin chuck 427. During the execution of the drying process of the substrate W, the drying nozzle 451 is placed in a processing position lying over the objective substrate W held by the spin chuck 427. After the drying process, the drying nozzle 451 is placed in a retracted position distant from the objective substrate W.

A drying supply pipe 473 has a first end connected to the drying nozzle 451. The drying supply pipe 473 has a second end connected through an on-off valve 474 to an inert gas supply source 475. When the on-off valve 474 is opened, an inert gas (e.g., nitrogen gas (N₂) or argon gas (Ar)) is supplied through the drying supply pipe 473 to the drying nozzle 451. This allows the inert gas to be fed from the drying nozzle 451 to the back surface of the substrate W.

A processing cup 423 for surrounding the substrate W held by the spin chuck 427 is provided around the spin chuck 427. A cylindrical partition wall 433 is provided inside the processing cup 423. A drainage space 431 for draining the cleaning liquid used for the processing of the substrate W is formed inside the partition wall 433 so as to surround the spin chuck 427. A collected liquid space 432 for collecting the cleaning liquid used for the processing of the substrate W is formed between the outer wall of the processing cup 423 and the partition wall 433 so as to surround the drainage space 431.

A drainage pipe 434 for guiding the cleaning liquid to a drainage processing apparatus (not shown) is connected to the drainage space 431, and a collection pipe 435 for guiding the cleaning liquid to a collection processing apparatus (not shown) is connected to the collected liquid space 432.

A splash guard 424 for preventing the cleaning liquid from the substrate W from splashing outwardly is provided over the processing cup 423. The splash guard 424 has a configuration rotationally symmetric with respect to a rotary shaft 425. A drainage guide groove 441 of a dog-legged cross-sectional configuration is formed annularly in the inner surface of an upper end portion of the splash guard 424. A collected liquid guide portion 442 defined by an outwardly downwardly inclined surface is formed in the inner surface of a lower end portion of the splash guard 424. A partition wall receiving groove 443 for receiving the partition wall 433 in the processing cup 423 is formed near the upper end of the collected liquid guide portion 442.

The splash guard 424 is driven to move upwardly and downwardly in a vertical direction by a guard driving mechanism (not shown) including a ball screw mechanism and the like. The guard driving mechanism moves the splash guard 424 upwardly and downwardly between a collection position in which the collected liquid guide portion 442 surrounds the edge portion of the substrate W held by the spin chuck 427 and a drainage position in which the drainage guide groove 441 surrounds the edge portion of the substrate W held by the spin chuck 427. When the splash guard 424 is in the collection position (the position shown in FIG. 11), the cleaning liquid splashed from the edge portion of the substrate W is guided by the collected liquid guide portion 442 into the collected liquid space 432, and is then collected through the collection pipe 435. When the splash guard 424 is in the drainage position, on the other hand, the cleaning liquid splashed from the edge portion of the substrate W is guided by the drainage guide groove 441 into the drainage space 431, and is then drained through the drainage pipe 434. In this manner, the drainage and collection of the cleaning liquid can be selectively carried out.

5. Procedure for Cleaning Process in Cleaning Processing Part 93

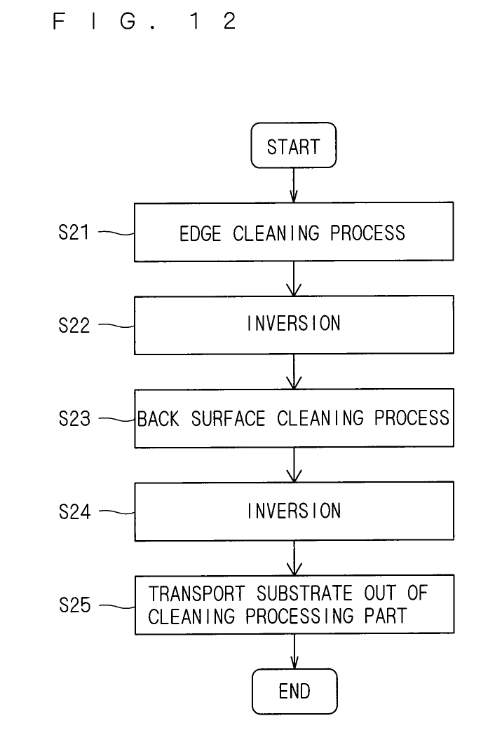

Next, a procedure for the process of cleaning an edge and a back surface of a substrate W (in Step S2 of FIG. 4) in the cleaning processing part 93 will be described with reference to FIG. 12. FIG. 12 is a flow diagram showing the operation of the cleaning processing part 93. The controller 91 (see FIG. 1) controls the operations of the respective components to be discussed below.

The indexer robot IR uses the pre-cleaning hand IRH1 to take an unprocessed substrate W out of a cassette C, and transports the unprocessed substrate W to the edge cleaning processing unit EC in the cleaning processing part 93. The edge cleaning processing unit EC performs the process of cleaning the edge of the substrate W (in Step S21).

The procedure for the process of cleaning the edge of the substrate W will be described in further detail. The indexer robot IR places the substrate W onto the spin chuck 210. Then, the spin chuck 210 holds the substrate W placed thereon under suction. Thus, the substrate W is held in a horizontal position.

Subsequently, the nozzle movement mechanism 220 moves the inclined U-shaped nozzle 230 from the retracted position to the processing position. This causes the edge of the substrate W to be inserted between the upper surface D1 and the lower surface D2 of the inclined U-shaped nozzle 230 so that the edge R is positioned in the interior space V of the inclined U-shaped nozzle 230.

Subsequently, the rotary shaft 211 starts rotating. This causes the substrate W held by the spin chuck 210 to rotate. Thereafter, the on-off valve 242 is opened, and a high-frequency current is supplied from the high-frequency generating device to the high-frequency vibrator 250 to ultrasonically vibrate the high-frequency vibrator 250. Then, the ultrasonically vibrated cleaning liquid is discharged from the ultrasonic nozzle 240 into the inclined U-shaped nozzle 230 to form the puddle L of ultrasonically vibrated cleaning liquid in the interior space V of the inclined U-shaped nozzle 230. The edge R of the substrate W positioned in the interior space V of the inclined U-shaped nozzle 230 is immersed in the puddle L. Thus, upon receiving the impact of the high-frequency vibration, particles and the like deposited on the edge R are released from the surface of the substrate W. That is, the edge R is cleaned. The liquid overflowing from the inclined U-shaped nozzle 230 is drained by a drainage mechanism not shown.

After a lapse of a predetermined time period, the supply of the cleaning liquid is stopped, and the rotation of the rotary shaft 211 is stopped. Then, the nozzle movement mechanism 220 moves the inclined U-shaped nozzle 230 from the processing position to the retracted position. The spin chuck 210 releases the holding of the substrate W under suction, and the indexer robot IR uses the post-cleaning hand IRH2 to take the substrate W subjected to the edge cleaning process from the edge cleaning processing unit EC. Thus, the process of cleaning the edge of the substrate W is completed.

Referring again to FIG. 12, after the process in Step S21, the indexer robot IR transports the substrate W subjected to the edge cleaning process and taken from the edge cleaning processing unit EC to the first inverting unit REV1. The first inverting unit REV1 inverts the substrate W so that the back surface thereof is positioned to face upward (in Step S22). The inverting operation in the inverting unit REV1 is as mentioned above. The term “front surface” of a substrate W used herein refers to a main surface to be patterned, and the term “back surface” of a substrate W refers to the surface opposite from the front surface.

After the process in Step S22, the indexer robot IR uses the post-cleaning hand IRH2 to take the inverted substrate W from the first inverting unit REV1, and transports the substrate W to the back surface cleaning unit SOAK. The back surface cleaning unit SOAK performs the process of cleaning the back surface of the substrate W (in Step S23).

The procedure for the process of cleaning the back surface of the substrate W will be described in further detail. During the transport of the substrate W into the back surface cleaning unit SOAK, the splash guard 424 is in a lowered position. The indexer robot IR places the substrate W onto the spin chuck 427. Then, the six support pins 428 of the spin chuck 427 grasp the edge portion of the substrate W placed on the spin chuck 427. Thus, the substrate W is held in a horizontal position, with the back surface thereof positioned to face upward.

Subsequently, the splash guard 424 moves to the above-mentioned drainage position, and the cleaning nozzle 450 moves to over the central portion of the substrate W. Then, the rotary shaft 425 starts rotating. This causes the substrate W held by the spin chuck 427 to rotate. Thereafter, the on-off valve 464 is opened to discharge the cleaning liquid from the cleaning nozzle 450 onto the upper surface (in this step, the back surface) of the substrate W. Thus, the process of cleaning the back surface of the substrate W proceeds to wash away the particles and the like deposited on the back surface of the substrate W. The liquid splashed from the rotating substrate W by centrifugal force is guided by the drainage guide groove 441 into the drainage space 431, and is drained through the drainage pipe 434.

After a lapse of a predetermined time period, the speed of rotation of the rotary shaft 425 decreases. This decreases the amount of cleaning liquid spattered by the rotation of the substrate W to form a film of cleaning liquid on the entire back surface of the substrate W in such a manner that a puddle of cleaning liquid remains on the substrate W. Alternatively, a film of cleaning liquid may be formed on the entire back surface of the substrate W by stopping the rotation of the rotary shaft 425.

Next, the supply of the cleaning liquid is stopped. The cleaning nozzle 450 is retracted to a predetermined position, and the drying nozzle 451 moves to over the central portion of the substrate W. Then, the on-off valve 474 is opened to apply an inert gas from the drying nozzle 451 to near the central portion of the upper surface of the substrate W. Thus, the cleaning liquid in the central portion of the back surface of the substrate W is forced toward the peripheral edge portion of the substrate W. As a result, the film of cleaning liquid remains only in the peripheral edge portion of the back surface of the substrate W.

Next, the speed of rotation of the rotary shaft 425 increases again, and the drying nozzle 451 gradually moves from over the central portion of the back surface of the substrate W toward over the peripheral edge portion thereof. Thus, a great centrifugal force is exerted on the film of cleaning liquid remaining on the back surface of the substrate W, and the inert gas impinges on the entire back surface of the substrate W, whereby the film of cleaning liquid is reliably removed from the substrate W. As a result, the substrate W is dried with reliability.

Next, the supply of the inert gas is stopped. The drying nozzle 451 is retracted to a predetermined position, and the rotation of the rotary shaft 425 is stopped. The splash guard 424 is moved downwardly, and the support pins 428 release the grasp of the edge portion of the substrate W. The indexer robot IR uses the post-cleaning hand IRH2 to take the substrate W subjected to the back surface cleaning process from the back surface cleaning unit SOAK. Thus, the process of cleaning the back surface of the substrate W is completed. The position of the splash guard 424 during the cleaning and drying processes is preferably appropriately changed depending on the need for the collection and drainage of the cleaning liquid.

Referring again to FIG. 12, after the process in Step S23, the indexer robot IR transports the substrate W subjected to the back surface cleaning process and taken from the back surface cleaning unit SOAK to the second inverting unit REV2. The second inverting unit REV2 inverts the substrate W so that the front surface thereof is positioned to face upward (in Step S24). The inverting operation in the inverting unit REV2 is as mentioned above.

After the process in Step S24, the indexer robot IR subsequently uses the post-cleaning hand IRH2 to take the inverted substrate W (the substrate W with the front surface positioned to face upward after the inverting process) from the second inverting unit REV2. The indexer robot IR rotates in the direction θ while moving in a direction of the X-axis, and places the substrate W onto the substrate rest part PASS1 (in Step S25). Thus, the process of cleaning the edge and the back surface of the substrate W is completed.

6. Effects

According to the above-mentioned embodiment, the provision of the cleaning processing part 93 in the indexer block 9 accomplishes savings in space for the apparatus. The edge cleaning processing unit EC is capable of cleaning the edge of a substrate before the substrate is transferred to the anti-reflection film processing block 10 which is a processor to thereby make the edge of the substrate to be transported into the anti-reflection film processing block 10 clean. The back surface cleaning unit SOAK is capable of cleaning the back surface of a substrate before the substrate is transferred to the anti-reflection film processing block 10 which is the processor to thereby make not only the edge but also the back surface of the substrate clean. This avoids a situation in which the execution of a series of processes on an unclean substrate gives rise to a defect. Also avoided is a situation in which a substrate with particles and the like deposited on an edge and a back surface thereof is transported into a track to cause contamination of the track and the exposure apparatus.

Also, according to the above-mentioned embodiment, the edge cleaning processing unit EC includes the ultrasonic nozzle 240 for supplying the cleaning liquid applied with ultrasonic vibration to the edge of the substrate W. Thus, the edge of the substrate W is cleaned with the cleaning liquid applied with ultrasonic vibration. This effectively removes the particles deposited on the edge of the substrate W.

Further, according to the above-mentioned embodiment, the edge cleaning processing unit EC includes the inclined U-shaped nozzle 230 which forms a puddle of cleaning liquid to immerse the edge of the substrate W in the puddle of cleaning liquid. Thus, the entire edge of the substrate W is brought into contact with the cleaning liquid with reliability. This produces a high cleaning effect. In particular, the cleaning liquid is distributed sufficiently around the edge of the substrate W if the surroundings of the edge of the substrate W are hydrophobic. Thus, the particles and the like deposited on the edge of the substrate W and its surroundings are removed with reliability.

Additionally, according to the above-mentioned embodiment, the hand (the pre-cleaning hand IRH1) for holding a substrate W prior to the cleaning of the edge thereof and the hand (the post-cleaning hand IRH2) for holding a substrate W after the cleaning of the edge thereof are used properly depending on the purposes. This avoids a situation in which an unclean hand holds a substrate W after the cleaning of the edge thereof to contaminate the substrate W again. Therefore, the substrate W with the cleaned edge is transported into the anti-reflection film processing block 10 while being maintained clean.

7. Modifications

7-1. Modifications of Layout of Indexer Block 9

The layout of the indexer block 9 in which the cleaning processing part 93 is disposed adjacent to the one or more cassette tables 92 is illustrated in the above-mentioned embodiment. The layout of the indexer block 9, however, is not limited to this.

First Modification of Layout of Indexer Block 9

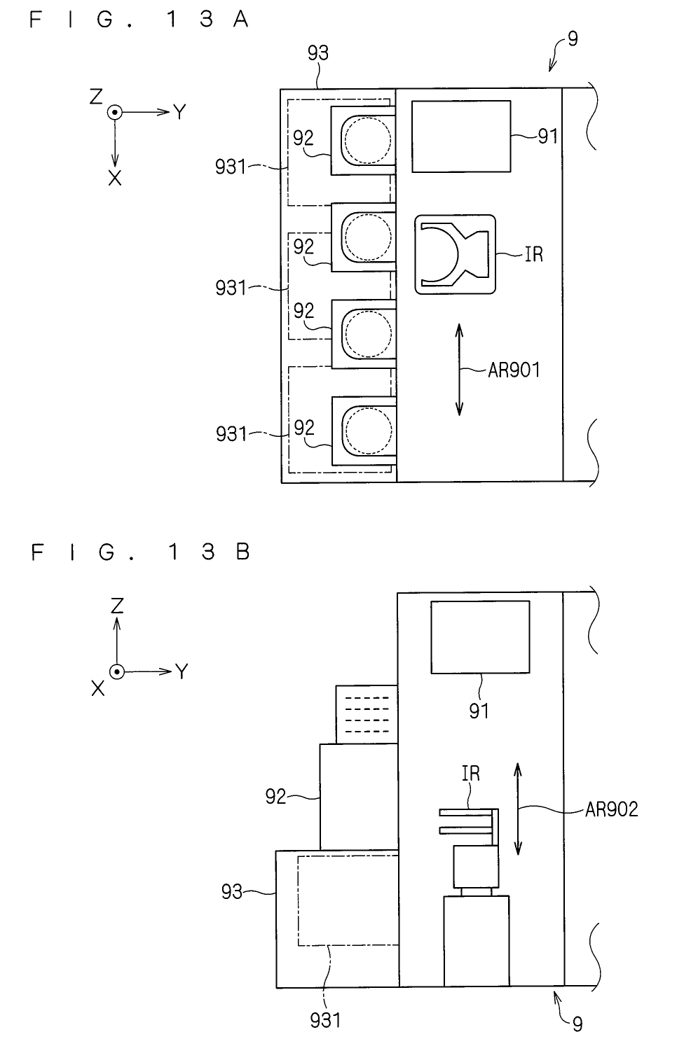

A first modification of the layout of the indexer block 9 will be described with reference to FIGS. 13A and 13B. FIGS. 13A and 13B are a plan view and a side view, respectively, showing the first modification of the layout of the indexer block 9.

In the first modification, the cleaning processing part 93 and the one or more cassette tables 92 are arranged in vertically stacked relation. Particularly preferably, the cleaning processing part 93 is disposed under the one or more cassette tables 92, as shown in FIG. 13B. The indexer robot IR is capable of being extended and retracted in the Z direction (as indicated by the arrow AR902) to gain access to the one or more cassette tables 92 or the cleaning processing part 93.

In the first modification, the one or more (in FIG. 13A, three) processing units 931 provided in the cleaning processing part 93 are disposed in adjacent relation to each other. The indexer robot IR is capable of moving in the X direction (as indicated by the arrow AR901) to gain access to any one of the processing units 931.

Second Modification of Layout of Indexer Block 9

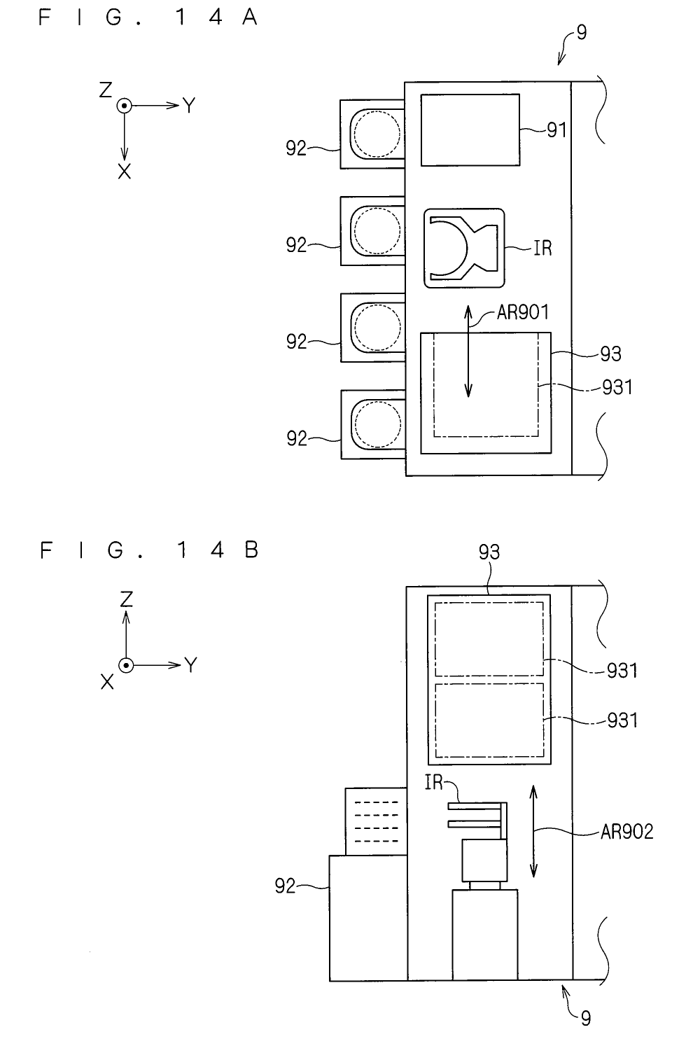

A second modification of the layout of the indexer block 9 will be described with reference to FIGS. 14A and 14B. FIGS. 14A and 14B are a plan view and a side view, respectively, showing the second modification of the layout of the indexer block 9.

In the second modification, the cleaning processing part 93 is disposed over the indexer robot IR. The indexer robot IR is capable of being extended and retracted in the Z direction (as indicated by the arrow AR902) to gain access to the cleaning processing part 93. It should be noted that the cleaning processing part 93 is disposed at a vertical position high enough not to interfere with the movement of the indexer robot IR in the X direction (as indicated by the arrow AR901).

In the second modification, the one or more (in FIG. 14A, two) processing units 931 provided in the cleaning processing part 93 are disposed in vertically stacked relation to each other. The indexer robot IR is capable of being extended and retracted in the Z direction (as indicated by the arrow AR902) to gain access to any one of the processing units 931.

7-2. Modifications of Edge Cleaning Processing Unit EC

The edge cleaning processing unit EC according to the above-mentioned embodiment is illustrated as configured to clean the edge of a substrate W by using the inclined U-shaped nozzle 230, the ultrasonic nozzle 240 and the like. The construction of the edge cleaning processing unit EC is not limited to this.

First Modification of Edge Cleaning Processing Unit EC

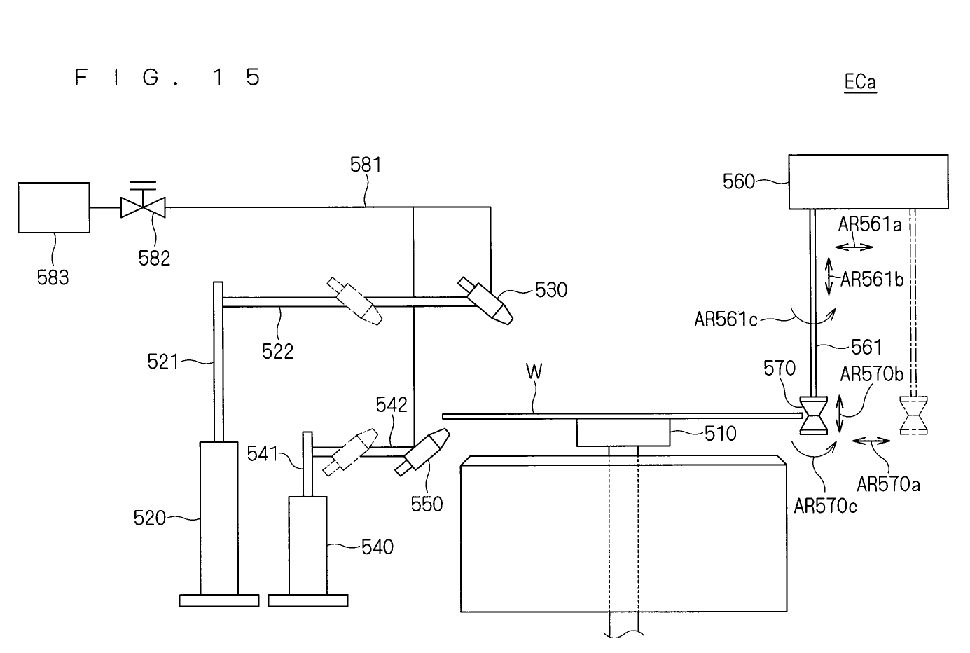

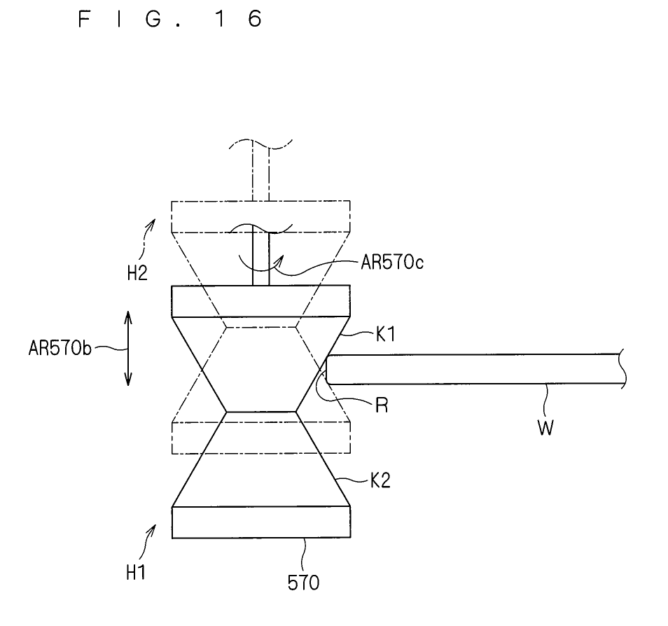

An edge cleaning processing unit ECa which is a first modification of the edge cleaning processing unit EC will be described with reference to FIGS. 15 and 16. FIG. 15 is a view showing the overall construction of the edge cleaning processing unit ECa according to the first modification. FIG. 16 is a side view showing a brush portion. The edge cleaning processing unit ECa principally includes a spin chuck 510, a first cleaning nozzle pivoting mechanism 520, a first cleaning nozzle 530, a second cleaning nozzle pivoting mechanism 540, a second cleaning nozzle 550, a brush movement mechanism 560, and a brush 570. The construction of the spin chuck 510 is similar to that of the above-mentioned spin chuck 210 (see FIG. 7), and will not be described.

The first cleaning nozzle pivoting mechanism 520 includes, for example, a pivot motor, and is disposed on one side of the spin chuck 510. A pivoting shaft 521 extending upwardly is connected to the first cleaning nozzle pivoting mechanism 520. An arm 522 extending in a horizontal direction is coupled to the pivoting shaft 521. The first cleaning nozzle pivoting mechanism 520 is drive-controlled to thereby pivot the arm 522.

The first cleaning nozzle 530 is mounted to the tip of the arm 522. The first cleaning nozzle pivoting mechanism 520 is drive-controlled to pivot the arm 522, thereby moving the first cleaning nozzle 530 to over the substrate W held by the spin chuck 510. During the execution of the edge cleaning process of the substrate W, the first cleaning nozzle 530 is placed in a processing position (indicated by the solid lines of FIG. 15) lying over the objective substrate W held by the spin chuck 510. After the edge cleaning process, the first cleaning nozzle 530 is placed in a retracted position (indicated by the phantom lines of FIG. 15) distant from the objective substrate W.

Like the first cleaning nozzle pivoting mechanism 520, the second cleaning nozzle pivoting mechanism 540 includes, for example, a pivot motor, and is disposed on the one side of the spin chuck 510. A pivoting shaft 541 extending upwardly is connected to the second cleaning nozzle pivoting mechanism 540. An arm 522 extending in a horizontal direction is coupled to the pivoting shaft 541. The second cleaning nozzle pivoting mechanism 540 is drive-controlled to thereby pivot the arm 542.

The second cleaning nozzle 550 is mounted to the tip of the arm 542, and is supported in such a position as to discharge the cleaning liquid toward the lower surface of the substrate W held by the spin chuck 510. The second cleaning nozzle pivoting mechanism 540 is drive-controlled to pivot the arm 542, thereby moving the second cleaning nozzle 550 to under the substrate W held by the spin chuck 510. During the execution of the edge cleaning process of the substrate W, the second cleaning nozzle 550 is placed in a processing position (indicated by the solid lines of FIG. 15) lying under the objective substrate W held by the spin chuck 510. After the edge cleaning process, the second cleaning nozzle 550 is placed in a retracted position (indicated by the phantom lines of FIG. 15) distant from the objective substrate W.

A cleaning liquid supply pipe 581 has a first end connected to the first cleaning nozzle 530 and the second cleaning nozzle 550. The cleaning liquid supply pipe 581 has a second end connected through an on-off valve 582 to a cleaning liquid supply source 583. When the on-off valve 582 is opened, the cleaning liquid is supplied through the cleaning liquid supply pipe 581 to the first cleaning nozzle 530 and the second cleaning nozzle 550. This allows the cleaning liquid to be fed from the first cleaning nozzle 530 to the upper surface of the substrate W, and allows the cleaning liquid to be fed from the second cleaning nozzle 550 to the lower surface of the substrate W.

The brush movement mechanism 560 is disposed on another side of the spin chuck 510 in an upper portion of the edge cleaning processing unit ECa. A rodlike brush support member 561 extending downwardly is mounted to the brush movement mechanism 560. The brush support member 561 is movable in a horizontal direction (as indicated by the arrow AR561a) and in a vertical direction (as indicated by the arrow AR561b) by controlling the driving of the brush movement mechanism 560. The brush movement mechanism 560 includes a rotary shaft (not shown) rotated by an electric motor, and the brush support member 561 is fixed on the lower end of the rotary shaft. That is, the brush support member 561 is rotatable about a vertical rotation axis (as indicated by the arrow AR561c) by controlling the driving of the brush movement mechanism 560.

The brush 570 is mounted to the lower end of the brush support member 561, and is approximately level with the substrate W held by the spin chuck 510. The brush movement mechanism 560 is drive-controlled to move the brush support member 561 in a horizontal direction, thereby moving the brush 570 in a horizontal direction (as indicated by the arrow AR570a). During the edge cleaning process of the substrate W, the brush 570 is placed in a processing position (indicated by the solid lines of FIG. 15) that is the position of the edge of the objective substrate W held by the spin chuck 510. During the edge cleaning process, the brush 570 is driven to rotate and to move upwardly and downwardly, which will be described later. After the edge cleaning process, the brush 570 is placed in a retracted position (indicated by the phantom lines of FIG. 15) distant from the position of the edge of the objective substrate W.

The brush 570 is formed of, for example, polyvinyl alcohol (PVA). As shown in FIG. 16, the brush 570 is circular in transverse cross-section, and has a shape inclined from the center toward the opposite ends in longitudinal cross-section.

For the process of cleaning the edge of the substrate W, the above-mentioned first and second cleaning nozzles 530 and 550 discharge the cleaning liquid toward the upper and lower surfaces, respectively, of the substrate W. In this state, the brush 570 additionally starts being driven to rotate (as indicated by the arrow AR570c). The rotating brush 570 is moved in a horizontal direction (as indicated by the arrow AR570a), and placed in the processing position that is the position of the edge of the substrate W held by the spin chuck 510.

The brush placed in the processing position is further moved in a vertical direction (as indicated by the arrow AR570b). Specifically, the brush 570 moves repeatedly between a first vertical position H1 (indicated by the solid lines of FIG. 16) and a second vertical position H2 (indicated by the phantom lines of FIG. 16). At the first vertical position H1, an upper inclined surface K1 of the brush 570 makes sliding contact from above with the edge R of the substrate W held by the spin chuck 510. Then, particles deposited near the upper side of the edge R are released from the surface of the substrate W under the physical force of the rotating brush 570. At the second vertical position H2 higher than the first vertical position H1, a lower inclined surface K2 of the brush 570 makes sliding contact from below with the edge R of the substrate W held by the spin chuck 510. Then, particles deposited near the lower side of the edge R are released from the surface of the substrate W under the physical force of the rotating brush 570. In other words, the edge R is cleaned both from above and from below by the movement of the brush 570 between the first vertical position H1 and the second vertical position H2.

According to this modification, the cleaning brush is brought into sliding contact with the edge of the substrate W to remove particles deposited on the edge of the substrate W with reliability.

Second Modification of Edge Cleaning Processing Unit EC

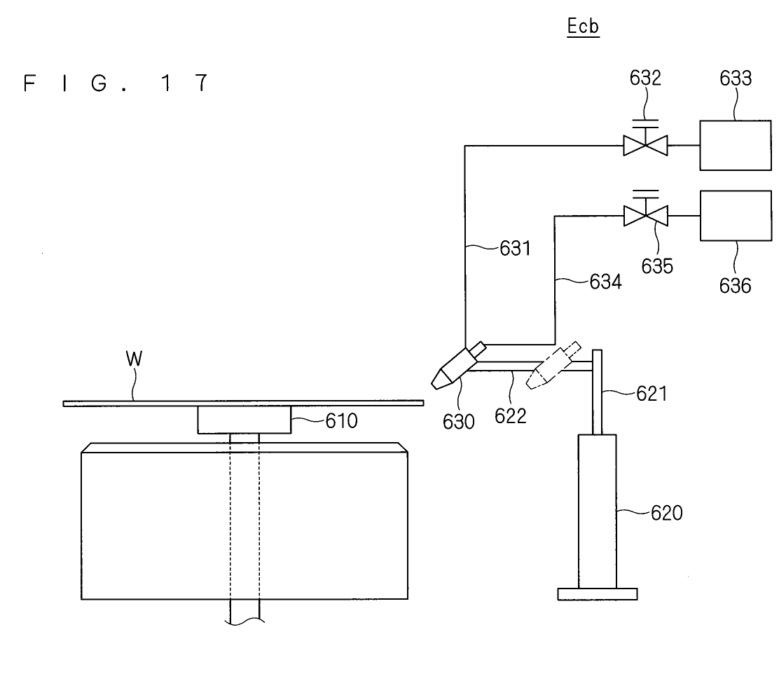

An edge cleaning processing unit ECb which is a second modification of the edge cleaning processing unit EC will be described with reference to FIG. 17. FIG. 17 is a view showing the overall construction of the edge cleaning processing unit ECb according to the second modification. The edge cleaning processing unit ECb principally includes a spin chuck 610, a nozzle pivoting mechanism 620, and a two-fluid nozzle 630. The construction of the spin chuck 610 is similar to that of the above-mentioned spin chuck 210 (see FIG. 7), and will not be described.

The nozzle pivoting mechanism 620 includes, for example, a pivot motor, and is disposed on one side of the spin chuck 610. A pivoting shaft 621 extending upwardly is connected to the nozzle pivoting mechanism 620. An arm 622 extending in a horizontal direction is coupled to the pivoting shaft 621. The nozzle pivoting mechanism 620 is drive-controlled to thereby pivot the arm 622.

The two-fluid nozzle 630 is mounted to the tip of the arm 622, and is supported in such a position as to discharge the cleaning liquid toward the edge R of the substrate W held by the spin chuck 610. The nozzle pivoting mechanism 620 is drive-controlled to pivot the arm 622, thereby moving the two-fluid nozzle 630 to over the substrate W held by the spin chuck 610. During the execution of the edge cleaning process of the substrate W, the two-fluid nozzle 630 is placed in a processing position (indicated by the solid lines of FIG. 17) which is a side position above the objective substrate W held by the spin chuck 610. After the edge cleaning process, the two-fluid nozzle 630 is placed in a retracted position (indicated by the phantom lines of FIG. 17) distant from the objective substrate W.

A first end of a cleaning liquid supply pipe 631 and a first end of a nitrogen gas supply pipe 634 are connected to the two-fluid nozzle 630. The cleaning liquid supply pipe 631 has a second end connected through an on-off valve 632 to a cleaning liquid supply source 633. When the on-off valve 632 is opened, the cleaning liquid is supplied through the cleaning liquid supply pipe 631 to the two-fluid nozzle 630. The nitrogen gas supply pipe 634 has a second end connected through an on-off valve 635 to a nitrogen gas supply source 636. When the on-off valve 635 is opened, nitrogen gas is supplied through the nitrogen gas supply pipe 634 to the two-fluid nozzle 630.

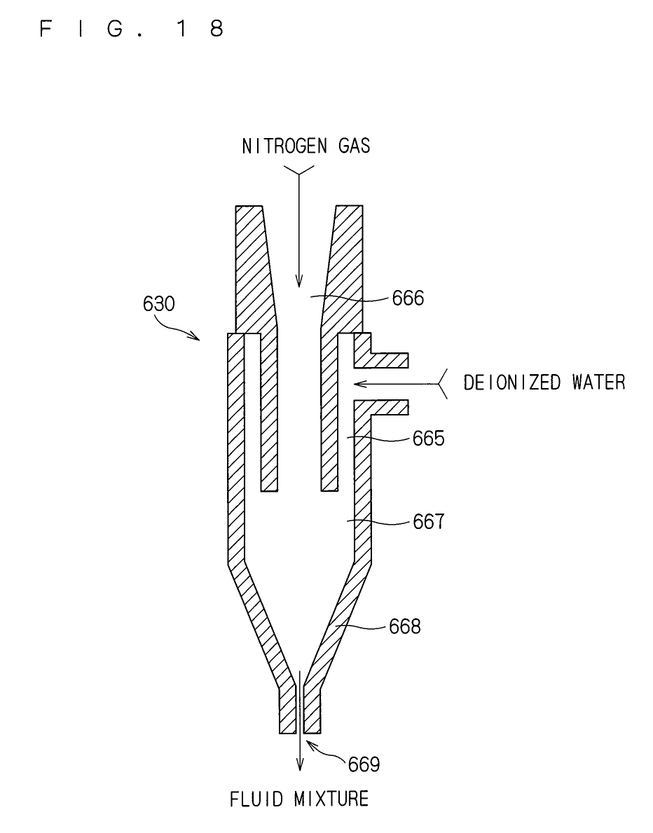

With reference to FIG. 18, the two-fluid nozzle 630 will be described in further detail. FIG. 18 is a side sectional view showing the two-fluid nozzle 630. The two-fluid nozzle 630 is a nozzle which mixes a cleaning liquid and a gas (e.g., nitrogen gas) together to form and discharge droplets of cleaning liquid. More specifically, the two-fluid nozzle 630 is what is called an internal mixing two-fluid nozzle which mixes the cleaning liquid supplied from the cleaning liquid supply source 633 and the nitrogen gas supplied from the nitrogen gas supply source 636 together inside the nozzle to form droplets of cleaning liquid in the form of a mist, thereby discharging the droplets toward the substrate W.

The two-fluid nozzle 630 has a double-pipe structure such that a gas inlet pipe 666 is inserted in a cleaning liquid inlet pipe 665. A mixing part 667 for mixing the nitrogen gas and the cleaning liquid together is provided downstream from an end of the gas inlet pipe 666 inside the cleaning liquid inlet pipe 665.

The cleaning liquid supplied to the cleaning liquid inlet pipe 665 and pressurized nitrogen gas supplied to the gas inlet pipe 666 are mixed together in the mixing part 667 to form a fluid mixture including droplets of cleaning liquid. The formed fluid mixture is accelerated by an acceleration pipe 668 downstream from the mixing part 667, and is discharged from an outlet port 669.

The two-fluid nozzle 630 may be what is called an external mixing two-fluid nozzle which mixes the nitrogen gas and the cleaning liquid together by causing a collision therebetween in an open space outside the nozzle to form droplets of cleaning liquid, thereby discharging the droplets toward the substrate W.

Particles deposited on the edge R of the substrate W are released from the surface of the substrate W by the droplets of cleaning liquid discharged toward the edge R of the substrate W. That is, the edge R is cleaned.

According to this modification, the edge of the substrate W is cleaned with the droplets of cleaning liquid generated by mixing the cleaning liquid and the gas together. This effectively removes particles deposited on the edge of the substrate W.

Third Modification of Edge Cleaning Processing Unit EC

In the above-mentioned embodiment, the ultrasonic nozzle 240 is mounted to the rear surface D3 of the inclined U-shaped nozzle 230. Instead, without the provision of the inclined U-shaped nozzle 230, the ultrasonic nozzle 240 may be configured to directly discharge the ultrasonically vibrated cleaning liquid toward the edge of the substrate W.

7-3. Modifications of Unit Configuration of Cleaning Processing Part 93

In the above description, the cleaning processing part 93 includes the one or more processing units 931 disposed in vertically stacked relation (or in adjacent relation as shown in FIG. 13A). In the above-mentioned embodiment, in particular, the cleaning processing part 93 includes the four processing units 931 (the edge cleaning processing unit EC, the two inverting units REV1 and REV2, and the back surface cleaning unit SOAK). The unit configuration of the cleaning processing part 93, however, is not limited to this.

First Modifications of Unit Configuration of Cleaning Processing Part 93

As an example, the cleaning processing part 93 may include only one processing unit 931 (the edge cleaning processing unit EC). In other words, it is not always necessary for the cleaning processing part 93 to include a functional part for inverting a substrate W and for cleaning the back surface thereof (the inverting unit REV and the back surface cleaning unit SOAK).

Second Modifications of Unit Configuration of Cleaning Processing Part 93

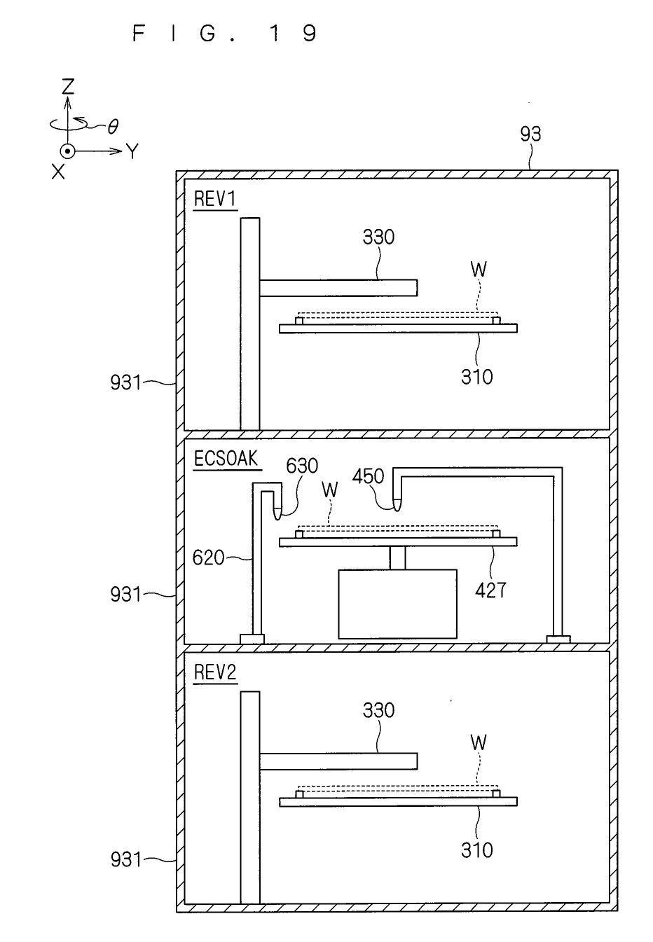

With reference to FIG. 19, as an example, the processing part for cleaning the edge of the substrate W (the edge cleaning processing unit EC) and the processing part for cleaning the back surface thereof (the back surface cleaning unit SOAK) may be combined together to form a single processing unit 931. In other words, the process of cleaning the edge and the process of cleaning the back surface may be performed in the same unit.

Such a processing unit (an edge and back surface cleaning unit ECSOAK) is attained by the provision of the functional parts for cleaning the edge (e.g., the nozzle pivoting mechanism 620 and the two-fluid nozzle 630 as shown in FIG. 17) in addition to the functional parts for cleaning the back surface (the spin chuck 427, the cleaning nozzle pivoting mechanism 460, the cleaning nozzle 450, the drying nozzle pivoting mechanism 470 and the drying nozzle 451 as shown in FIG. 11).

The edge and back surface cleaning unit ECSOAK receives a substrate W assuming a position such that the back surface thereof is positioned to face upward and the front surface that is the main surface to be patterned is positioned to face downward. It is therefore desirable that the spin chuck of the edge and back surface cleaning unit ECSOAK is of the type which grasps the edge portion of the substrate W, rather than of the type which holds the lower surface of the substrate W under vacuum suction.

For the spin chuck of the type which grasps the edge portion of the substrate W, there is a likelihood that particles and the like remain in edge portions of the substrate W in contact with the support pins which cannot be cleaned. To overcome such a disadvantage, it is desirable to perform the operation (a shifting operation) of changing the support pins which grasp the substrate W in the course of the edge cleaning. As an example, 12 support pins are mounted upright on a peripheral portion of the upper surface of the spin chuck. In the initial stage, six of the 12 support pins are used to grasp the substrate W. After the process of cleaning the edge proceeds partway, the six support pins are changed to the remaining six support pins to grasp the substrate W.

The use of a spin chuck of the type which supports a substrate W in anon-contacting manner (e.g., a chuck (a Bernoulli chuck) which supports a substrate W by the use of the Bernoulli effect by issuing a jet of gas from a slit opening provided in a support toward the substrate W) allows the use of the inclined U-shaped nozzle 230 (see FIG. 7) and the brush 570 (see FIG. 15) mentioned above as the mechanism for cleaning the edge.

In this manner, the configuration in which the process of cleaning the edge and the process of cleaning the back surface are performed in the same unit offers advantages in space saving and in cost reduction.

Third Modifications of Unit Configuration of Cleaning Processing Part 93

In the above-mentioned embodiment, the two inverting units REV1 and REV2 are provided as the processing units 931. However, the single inverting unit REV may be provided. In other words, a first inverting process for inverting a substrate W so that the back surface is positioned to face upward and a second inverting process for inverting the substrate W so that the back surface is positioned to face downward after the process of cleaning the back surface may be performed either in respectively separate units or in the same unit.

The configuration in which the two inverting processes are performed in respectively separate units as in the above-mentioned embodiment offers an advantage in preventing the substrate W subjected to the back surface cleaning process from being contaminated by the inverting mechanism of the inverting unit REV. On the other hand, the configuration in which the two inverting processes are performed in the same inverting unit REV as in this modification offers advantages in space saving and in cost reduction because there is no need to provide two inverting units REV1 and REV2.

7-4. Modification of Indexer Robot IR

In the above-mentioned embodiment, the indexer robot IR includes the single pre-cleaning hand IRH1 and the single post-cleaning hand IRH2 to transport a substrate W thereinto and therefrom by the use of a total of two hands. Alternatively, the indexer robot IR may include one pre-cleaning hand IRH1 and two post-cleaning hands IRH2 to transport a substrate W thereinto and therefrom by the use of a total of three hands.

In the configuration in which the indexer robot IR includes two post-cleaning hands IRH2, the processes of transferring substrates W subjected to the cleaning process (i.e., the process of transferring a substrate W to and from the cleaning processing part 93 and the process of transferring a substrate W to and from the anti-reflection film processing block 10) may be performed simultaneously by the use of the two post-cleaning hands IRH2.

While the invention has been described in detail, the foregoing description is in all aspects illustrative and not restrictive. It is understood that numerous other modifications and variations can be devised without departing from the scope of the invention.

What is claimed is:

1. A substrate processing apparatus comprising:
a processor including at least one processing unit for performing a predetermined process on a substrate; and
an indexer part for receiving an unprocessed substrate from outside to transfer the unprocessed substrate to the processor and for receiving a processed substrate from the processor to transport the processed substrate to outside, the indexer part including an edge cleaning part for cleaning an edge of a substrate prior to the transfer of the substrate to the processor.

2. The substrate processing apparatus according to claim 1 wherein the edge cleaning part includes:
an ultrasonic vibration application element for applying ultrasonic vibration to a predetermined cleaning liquid; and
a discharge nozzle for supplying the predetermined cleaning liquid applied with the ultrasonic vibration to an edge of a substrate to be cleaned.

3. The substrate processing apparatus according to claim 2 wherein the edge cleaning part further includes a puddle formation member of an inclined U-shaped cross-sectional configuration such that opposite horizontal end portions thereof are open; and
the edge cleaning part discharges the predetermined cleaning liquid from the discharge nozzle into an interior space of the puddle formation member to form a puddle, and immerses the edge of the substrate to be cleaned in the puddle to clean the edge of the substrate to be cleaned.

4. The substrate processing apparatus according to claim 1 wherein the edge cleaning part includes a two-fluid nozzle for mixing a predetermined cleaning liquid and a pressurized gas together to form droplets of the predetermined cleaning liquid, thereby supplying the droplets of the predetermined cleaning liquid to an edge of a substrate to be cleaned.

5. The substrate processing apparatus according to claim 1 wherein the edge cleaning part includes:
a cleaning liquid supply element for supplying a predetermined cleaning liquid to a substrate to be cleaned; and
a cleaning brush for making sliding contact with an edge of the substrate to be cleaned.

6. The substrate processing apparatus according to claim 1 wherein the indexer part further includes:
an inverting part for inverting a substrate prior to the transfer of the substrate to the processor upside down; and
a back surface cleaning part for cleaning a back surface of a substrate prior to the transfer of the substrate to the processor.

7. The substrate processing apparatus according to claim 1 wherein the indexer part further includes:
a cassette table for placing thereon a cassette for storing a plurality of substrates therein; and
a substrate transport device for holding a substrate with a predetermined holding element to transport the substrate between the cassette, the processor and the edge cleaning part, the substrate transport device including a first holding element for holding a substrate prior to the cleaning of an edge thereof and a second holding element for holding a substrate after the cleaning of an edge thereof.

8. A method of processing a substrate comprising:
a) receiving an unprocessed substrate to be processed in a processor into an indexer part, the processor including at least one processing unit for performing a predetermined process on a substrate, the indexer part transferring a substrate to and from the processor;
b) cleaning an edge of the substrate in the indexer part; and
c) transporting the substrate with the edge cleaned from the indexer part to the processor.

9. The method according to claim 8 wherein step b) includes supplying a predetermined cleaning liquid applied with ultrasonic vibration to an edge of a substrate to be cleaned.

10. The method according to claim 9 wherein step b) further includes forming a puddle of the predetermined cleaning liquid applied with the ultrasonic vibration in an internal space of a puddle formation member to immerse the edge of the substrate to be cleaned in the puddle, the puddle formation member being of an inclined U-shaped cross-sectional configuration such that opposite horizontal end portions thereof are open.

11. The method according to claim 8 wherein step b) includes mixing a predetermined cleaning liquid and a pressurized gas together to form droplets of the predetermined cleaning liquid, thereby supplying the droplets of the predetermined cleaning liquid to an edge of a substrate to be cleaned.

12. The method according to claim 8 wherein step b) includes:
supplying a predetermined cleaning liquid to a substrate to be cleaned; and
bringing a cleaning brush into sliding contact with an edge of the substrate to be cleaned.

13. The method according to claim 8 further comprising:
inverting the substrate after the cleaning of the edge thereof upside down in the indexer part so that a back surface of the substrate opposite from a patterned surface is positioned to face upward;
cleaning the back surface in the indexer part; and
inverting the substrate with the back surface cleaned upside down in the indexer part so that the back surface is positioned to face downward.

14. The method according to claim 8 wherein a first holding element is used to hold a substrate prior to the cleaning of an edge thereof, and a second holding element is used to hold a substrate after the cleaning of an edge thereof.
